(19) United States
(12) Patent Application Publication
(10) Pub. No.: US 2026/0246971 A1
(43) Pub. Date: Aug. 20, 2026

(54) 3D DATA TRANSMISSION DEVICE, 3D DATA TRANSMISSION METHOD, 3D DATA RECEPTION DEVICE, AND 3D DATA RECEPTION METHOD

(71) Applicant: LG ELECTRONICS INC., Seoul (KR)

(72) Inventors: Hanje PARK, Seoul (KR); Naseong KWON, Gyeonggi-do (KR); Donggyu SIM, Seoul (KR)

(73) Assignee: LG ELECTRONICS INC., Seoul (KR)

(21) Appl. No.: 19/164,520

(22) PCT Filed: Mar. 14, 2024
(86) PCT No.: PCT/KR2024/095520

§ 371 Date: Sep. 11, 2025

(30) Foreign Application Priority Data
Mar. 14, 2023 (KR) 10-2023-0033566

(51) Int. Cl. H04N 19/597; G06T 15/04; G06T 17/20; H04N 19/119; H04N 19/85

(52) U.S. Cl. CPC H04N 19/597; G06T 15/04; G06T 17/20; H04N 19/119; H04N 19/85

(57) ABSTRACT

A 3D data decoding device according to embodiments may comprise: a base mesh restoration unit for restoring a base mesh from a base mesh bitstream; a displacement vector restoration unit for restoring a displacement vector from a displacement vector bitstream; a restoration unit for restoring a mesh on the basis of the restored base mesh and the restored displacement vector; and a texture map restoration unit for restoring a texture map from a texture map bitstream.

### TECHNICAL FIELD

Embodiments provide a method for providing 3D content to provide a user with various services such as virtual reality (VR), augmented reality (AR), mixed reality (MR), and self-driving services.

### BACKGROUND

Point cloud data or mesh data in 3D content is a set of points in 3D space. However, it is difficult to create point cloud data or mesh data due to the large amount of points in 3D space.

In other words, a large throughput is required to transmit and receive 3D data with a considerable number of points, such as a point cloud or mesh data.

### DISCLOSURE

### Technical Problem

An object of the present disclosure is to provide an apparatus and method for efficiently transmitting and receiving mesh data to resolve the aforementioned issue.

Another object of the present disclosure is to provide an apparatus and method to address the latency and encoding/decoding complexity of mesh data.

Another object of the present disclosure is to provide an apparatus and method for performing subdivision by adaptively applying a subdivision level to mesh data.

However, the scope of the embodiments is not limited to the objects described above, and the scope of the embodiments may be expanded to other objects to be inferred by a person skilled in the art based on the entire contents of the present disclosure.

### Technical Solution

To obtain the objects described above and other advantages, according to embodiments, a three-dimensional (3D) data decoding apparatus includes a base mesh reconstructor configured to reconstruct a base mesh from a base mesh bitstream, a displacement vector reconstructor configured to reconstruct a displacement vector from a displacement vector bitstream, a reconstructor configured to reconstruct a mesh based on the reconstructed base mesh and the reconstructed displacement vector, and a texture map reconstructor configured to reconstruct a texture map from a texture map bitstream.

According to embodiments, the 3D data decoding apparatus may further include a mesh feature extractor configured to extract a feature value of the base mesh or subdivided mesh for each preset unit, an iteration count determination unit configured to determine whether to perform subdivision and a subdivision iteration count for each subdivision unit based on the extracted feature value, and a mesh subdivision unit configured to subdivide a mesh of a corresponding subdivision unit based on the determined subdivision iteration count

According to embodiments, the preset unit may be at least one of a vertex unit, a face unit, or a fan unit.

According to embodiments, the subdivision unit may be a base mesh of a face unit or a reconstructed mesh of a face unit.

According to embodiments, the reconstructed mesh of the face unit may be a mesh reconstructed by applying a reconstructed displacement vector to a mesh of a subdivided face.

According to embodiments, a 3D data encoding apparatus includes a base mesh processor configured to generate a base mesh bitstream by encoding a base mesh generated by decimating an original mesh, a displacement vector processor configured to generate a displacement vector bitstream by encoding a displacement vector generated based on the base mesh, a mesh reconstructor configured to reconstruct a mesh based on the encoded base mesh and the encoded displacement vector, and a texture map processor configured to generate a texture map bitstream by encoding a texture map generated based on the original mesh and the reconstructed mesh.

According to embodiments, the 3D data encoding apparatus may further include a mesh feature extractor configured to extract a feature value of the base mesh or subdivided mesh for each preset unit, an iteration count determination unit configured to determine whether to perform subdivision and a subdivision iteration count for each subdivision unit based on the extracted feature value, and a mesh subdivision unit configured to subdivide a mesh of a corresponding subdivision unit based on the determined subdivision iteration count.

According to embodiments, the preset unit may be at least one of a vertex unit, a face unit, or a fan unit.

According to embodiments, the subdivision unit may be a base mesh of a face unit or a reconstructed mesh of a face unit.

According to embodiments, the reconstructed mesh of the face unit may be a mesh reconstructed by applying a reconstructed displacement vector to a mesh of a subdivided face.

According to embodiments, a 3D data transmission method includes encoding an original mesh, and transmitting a bitstream including the encoded mesh and signaling information.

According to embodiments, the encoding may include generating a base mesh bitstream by encoding a base mesh generated by decimating the original mesh, generating a displacement vector bitstream by encoding a displacement vector generated based on the base mesh, reconstructing a mesh based on the encoded base mesh and the encoded displacement vector, and generating a texture map bitstream by encoding a texture map generated based on the original mesh and the reconstructed mesh.

According to embodiments, the encoding may include extracting a feature value of the base mesh or subdivided mesh for each preset unit, determining whether to perform subdivision and a subdivision iteration count for each subdivision unit based on the extracted feature value, and subdividing a mesh of a corresponding subdivision unit based on the determined subdivision iteration count.

According to embodiments, the preset unit may be at least one of a vertex unit, a face unit, or a fan unit.

According to embodiments, the subdivision unit may be a base mesh of a face unit or a reconstructed mesh of a face unit.

According to embodiments, the reconstructed mesh of the face unit may be a mesh reconstructed by applying a reconstructed displacement vector to a mesh of a subdivided face.

According to embodiments, a computer-readable recording medium may be combined with a computer as hardware and may record a computer program for executing the method.

### Advantageous Effects

According to embodiments, a three-dimensional (3D) data transmission method, a 3D data transmitting apparatus, a 3D data receiving method, and a 3D data receiving apparatus may provide a 3D service with high quality.

According to embodiments, a 3D data transmission method, a 3D data transmitting apparatus, a 3D data receiving method, and a 3D data receiving apparatus may obtain various video codec methods.

According to embodiments, a 3D data transmission method, a 3D data transmitting apparatus, a 3D data receiving method, and a 3D data receiving apparatus may provide general-purpose 3D content such as an autonomous driving service.

According to embodiments, a 3D data transmission method, a 3D data transmitting apparatus, a 3D data receiving method, and a 3D data receiving apparatus may adaptively derive a subdivision iteration count of a dynamic mesh for each subdivision iteration unit based on a mesh feature and perform subdivision, and thus may omit transmission of information about the subdivision iteration count and the subdivision iteration unit to a mesh decoder of a receiving apparatus. Thus, a bit amount of signaling information may be reduced.

According to embodiments, a 3D data transmission method, a 3D data transmitting apparatus, a 3D data receiving method, and a 3D data receiving apparatus may have an advantage in that the amount of displacement vector bits is to be reduced as the number of vertices to be reconstructed is reduced when subdivision is not performed for a specific subdivision iteration unit by adaptively setting a subdivision level for each subdivision iteration unit.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. For a better understanding of various embodiments described below, reference should be made to the description of the following embodiments in connection with the accompanying drawings. The same reference numbers will be used throughout the drawings to refer to the same or like parts. In the drawings:

FIG. 1 illustrates a system for providing dynamic mesh content according to embodiments;

FIG. 2 illustrates a V-MESH compression method according to embodiments;

FIG. 3 illustrates pre-processing in V-MESH compression according to embodiments;

FIG. 4 illustrates a mid-edge subdivision method according to embodiments;

FIG. 5 illustrates a displacement generation process according to embodiments;

FIG. 6 illustrates an intra-frame encoding process for V-MESH data according to embodiments;

FIG. 7 illustrates an inter-frame encoding process for V-MESH data according to embodiments;

FIG. 8 illustrates a lifting transform process for displacements according to embodiments;

FIG. 9 illustrates a process of packing transform coefficients into a 2D image according to embodiments;

FIG. 10 illustrates an attribute transfer process in a V-MESH compression method according to embodiments;

FIG. 11 illustrates an intra-frame decoding process for V-MESH data according to embodiments;

FIG. 12 illustrates an inter-frame decoding process for V-MESH data according to embodiments;

FIG. 13 illustrates a mesh data transmission apparatus according to embodiments;

FIG. 14 illustrates a mesh data reception apparatus according to embodiments;

FIG. 15 is a diagram showing another example of a transmitting apparatus according to embodiments;

FIG. 16 is a diagram showing an example in which an encoder performs mesh subdivision based on the mesh feature according to embodiments;

FIG. 17(a) and 17(b) are diagrams showing examples of original meshes and base meshes expressed in 1D according to embodiments;

FIG. 18(a) to 18(d) are diagrams showing an example of a process of performing a non-uniform mesh subdivision process based on the vertex feature according to embodiments;

FIG. 19 is a diagram showing an example of a method of determining a subdivision count according to embodiments;

FIG. 20(a) to 20(c) are diagrams showing an example of a mesh subdivision process performed by an encoder according to embodiments;

FIG. 21(a) to 21(c) are diagrams showing another example of a mesh subdivision process performed by an encoder according to embodiments;

FIG. 22 is a diagram showing another example of a receiving apparatus according to embodiments;

FIG. 23 is a diagram showing an example in which a decoder performs mesh subdivision based on the mesh feature according to embodiments;

FIG. 24 is a diagram showing an example of a method of determining a subdivision count in a decoder according to embodiments;

FIG. 25(a) to 25(c) are diagrams showing an example of a process of performing mesh subdivision in a decoder according to embodiments;

FIG. 26 is a diagram showing an example of a syntax structure of signaling information according to embodiments;

FIG. 27 is a flowchart showing an example of a transmission method according to embodiments; and

FIG. 28 is a flowchart showing an example of a receiving method according to embodiments.

### DETAILED DESCRIPTION

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

With recent advancements in 3D data modeling and rendering technologies, research on generating and processing 3D data has been actively conducted across various fields, including virtual reality (VR), augmented reality (AR), autonomous driving, computer-aided design (CAD)/computer-aided manufacturing (CAM), and geographic information systems (GIS). 3D data may be represented as a point cloud or a mesh depending on the representation format. A mesh is composed of geometry information indicating the coordinates of each vertex or point, connectivity information indicating connections between vertices, a texture map representing color information about the mesh surface as 2D image data, and texture coordinates indicating the mapping information between the surface of the mesh and the texture map. In the present disclosure, a mesh is defined as a dynamic mesh when at least one of the elements constituting the mesh changes over time, and is defined as a static mesh when it does not change.

Dynamic mesh data involves significantly larger amounts of data of elements to represent the mesh compared to 2D image data. As a result, techniques for efficiently compressing a large amount of mesh data have been developed to store and transmit the data.

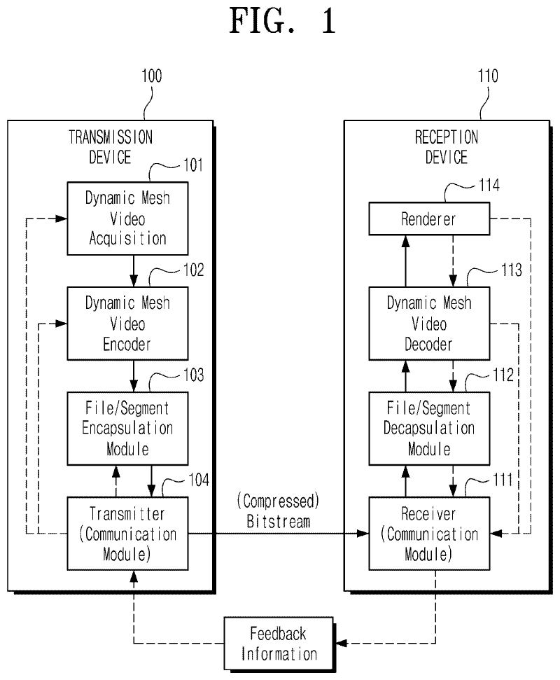

FIG. 1 illustrates a system for providing dynamic mesh content according to embodiments.

The system in FIG. 1 includes a transmission apparatus 100 and a reception apparatus 110. The transmission apparatus 100 may include a mesh video acquisition unit (or part) 101, a mesh video encoder 102, a file/segment encapsulator 103, and a transmitter 104. The reception apparatus 110 may include a receiver 111, a file/segment decapsulator 112, a mesh video decoder 113, and a renderer 114. Each component in FIG. 1 may correspond to hardware, software, a processor, and/or a combination thereof. In the following description, a mesh data transmission apparatus according to embodiments may be interpreted as referring to a 3D data transmission apparatus or transmission apparatus 100, or as referring to a mesh video encoder (hereinafter, encoder) 102. A mesh data reception apparatus according to embodiments may be interpreted as referring to a 3D data reception apparatus or reception apparatus 110, or as referring to a mesh video decoder (hereinafter, decoder) 113.

The system of FIG. 1 may perform video-based dynamic mesh compression and decompression.

With advancements in 3D capture, modeling, and rendering, users are allowed to access 3D content in various forms, such as AR, XR, metaverse, and holograms, across multiple platforms and devices. 3D content is increasingly becoming sophisticated and realistic in its representation of objects to provide immersive experiences for users. However, this requires a substantial amount of data for generation and use of 3D models. Among the various types of 3D content, 3D meshes are widely used for efficient data utilization and realistic object representation. Embodiments include a series of processing steps in a system that uses mesh content.

First, the method of compressing dynamic mesh data starts with the Video-based point cloud compression (V-PCC) standard technique for point cloud data. Point cloud data is data that has color information in the coordinates (X, Y, Z) of vertices (or points). In the present disclosure, vertex coordinates (i.e., position information) are referred to as geometry information, color information about vertices is referred to as attribute information. The geometry information and attribute information are together referred to as vertex information or point cloud data. Mesh data refers to vertex information including inter-vertex connectivity information. Content may be originally created in the form of mesh data. Alternatively, connectivity information may be added to point cloud data, and the point cloud data may be transformed into mesh data.

Currently, the MPEG standards group defines two data types for dynamic mesh data: Category 1 of mesh data having a texture map as color information, and Category 2 of mesh data having vertex colors as color information.

Mesh coding standards for Category 1 data are currently underway, and standardization for Category 2 data is expected to follow. The overall process for providing a mesh content service may include acquisition, encoding, transmission, decoding, rendering, and/or feedback processes, as shown in FIG. 1.

To provide mesh content services, 3D data acquired through multiple cameras or special cameras may be processed into a mesh data type through a series of steps to generate a mesh video. The generated mesh video may be transmitted through a series of operations, and the receiving side may process the received data back into a mesh video for rendering. Through this process, the mesh video may be provided to the user, allowing the user to utilize the mesh content interactively according to their intent.

As shown in FIG. 1, a mesh compression system may include a transmission apparatus 100 and a reception apparatus 110. The transmission apparatus 100 may encode the mesh video to output a bitstream, which may be delivered to the reception apparatus 110 over a digital storage medium or a network in the form of file or streaming (streaming segments). The digital storage medium may include various storage media such as USB, SD, CD, DVD, Blu-ray, HDD, and SSD.

In the transmission apparatus 100, the encoder may be referred to as a mesh video/image/picture/frame encoding device. In the reception apparatus 110, the decoder may be referred to as a mesh video/image/picture/frame decoding device. A transmitter may be included in the mesh video encoder, and a receiver may be included in the mesh video decoder. The renderer 114 may include a display, and the renderer and/or display may be configured as separate devices or external components. The transmission apparatus 100 and reception apparatus 110 may further include separate internal or external modules/units/components for the feedback process.

Mesh data represents the surface of an object using multiple polygons. Each polygon is defined by vertices in 3D space and connectivity information indicating how the vertices are connected. Additionally, vertex attributes such as color and normal vectors may be included in the data. Mapping information, which allows the surface of the mesh to be mapped onto a 2D plane, may also be included in the attributes of the mesh. The mapping is generally described using a set of parametric coordinate related to mesh vertices, referred to as UV coordinates or texture coordinates, related to related to the vertices of the mesh. A mesh contains a 2D attribute map, which may be used to store high-resolution attribute information such as texture, normal, and displacement. Here, the displacement may be used interchangeably with displacement information or a displacement vector.

The mesh video acquisition unit 101 may include processing 3D object data acquired through a camera or the like into a mesh data type having the attributes described above through a series of operations and generating a video composed of the mesh data. In the mesh video, the attributes of the mesh, such as vertices, polygons, connectivity between vertices, color, and normal, may change over time. A mesh video with attributes and connectivity information that change over time is referred to as a dynamic mesh video.

The mesh video encoder 102 may encode an input mesh video into one or more video streams. A video may contain multiple frames, each of which may correspond to a still image/picture. In the present disclosure, the mesh video may include mesh images/frames/pictures. The term “mesh video” may be used interchangeably with mesh images/frames/pictures. The mesh video encoder 102 may perform a Video-based Dynamic Mesh (V-Mesh) compression procedure. For compression and coding efficiency, the mesh video encoder 102 may perform a series of procedures such as prediction, transformation, quantization, and entropy coding. Encoded data (encoded video/image information) may be output in the form of a bitstream.

The file/segment encapsulation module 103 may encapsulate encoded mesh video data and/or mesh video-related metadata in the form of a file or the like. The mesh video-related metadata may be received from a metadata processor. The metadata processing unit may be included in the mesh video encoder 102, or may be configured as a separate component/module. The file/segment encapsulation module 103 may encapsulate the data into a file format such as ISOBMFF or process the same into forms such as DASH segments. According to embodiments, the file/segment encapsulator 103 may include the mesh video-related metadata in the file format. For example, the mesh video metadata may be included in boxes at various levels in the ISOBMFF file format, or as data on separate tracks in the file. In some embodiments, the file/segment encapsulator 103 may encapsulate the mesh video-related metadata into a file.

The transmission processor may apply processing to the encapsulated mesh video data for transmission based on the file format. The transmission processor may be included in the transmitter 104 or implemented as a separate component/module. The transmission processor may process the mesh video data according to any transmission protocol. The processing for transmission may include processing for delivery over a broadcast network and processing for delivery over a broadband. In some embodiments, the transmission processor may receive mesh video-related metadata from the metadata processor, as well as the mesh video data, and process the same for transmission.

The transmitter 104 may transmit the encoded video/image information or data output in bitstream form to the receiver 111 of the reception apparatus 110 over a digital storage medium or network in the form of a file or streaming. The digital storage medium may include various storage media such as USB, SD, CD, DVD, Blu-ray, HDD, and SSD. The transmitter 104 may include an element to generate a media file through a predetermined file format, and may include an element for transmission over a broadcast/communication network. The receiver 111 may extract the bitstream and deliver the same to a decoding device.

The receiver 111 may receive the mesh video data transmitted by the mesh data transmission apparatus. Depending on the channel for transmission, the receiver 111 may receive the mesh video data over a broadcast network or a broadband network, or may receive the mesh video data over a digital storage medium.

The reception processor may perform processing on the received mesh video data according to the transmission protocol. The reception processor may be included in the receiver 111, or may be configured as a separate component/module. To correspond to the processing performed for transmission on the transmitting side, the reception processor may perform the reverse process to the operations of the transmission processor described above. The reception processor may deliver the acquired mesh video data to the file/segment decapsulator 112 and the acquired mesh video-related metadata to the metadata parser. The mesh video-related metadata acquired by the reception processor may be in the form of a signaling table.

The file/segment decapsulator 112 may decapsulate mesh video data in the form of files received from the reception processor. The file/segment decapsulator 112 may decapsulate the files according to ISOBMFF or the like to acquire a mesh video bitstream or mesh video-related metadata (metadata bitstream). The acquired mesh video bitstream may be delivered to the mesh video decoder 113, and the acquired mesh video-related metadata (metadata bitstream) may be delivered to the metadata processor. The mesh video bitstream may include metadata (metadata bitstream). The metadata processor may be included in the mesh video decoder 113, or may be configured as a separate component/module. The mesh video-related metadata acquired by the file/segment decapsulator 112 may be in the form of boxes or tracks in the file format. The file/segment decapsulator 112 may receive metadata required for decapsulation from the metadata processor, when necessary. The mesh video-related metadata may be delivered to the mesh video decoder 113 for use in the mesh video decoding procedure, or to the renderer 114 for use in the mesh video rendering procedure.

The mesh video decoder 113 may receive the input bitstream and perform the reverse operation corresponding to the operation of the mesh video encoder 102 to decode the video/images. The decoded mesh video/images may be displayed through the display of the renderer 114. The user may view all or a portion of the rendered result through a VR/AR display, a general display, or the like.

The feedback process may include transmitting various kinds of feedback information that may be acquired during the rendering/display operation to the transmitting side or to the decoder on the receiving side. The feedback process may provide interactivity in consuming the mesh video. In some embodiments, the feedback process may include transmitting head orientation information, viewport information indicative of an area the user is currently viewing, and the like. In some embodiments, the user may interact with objects implemented in the VR/AR/MR/autonomous driving environment. In this case, the information related to the interaction may be delivered to the transmitting side or service provider during the feedback process. In some embodiments, the feedback process may be skipped.

The head orientation information may refer to information about the user's head position, angle, movement, etc. Based on this information, information about the area that the user is currently viewing within the mesh video, i.e., viewport information, may be calculated.

The viewport information may be information about the area in the mesh video that the user is currently viewing. Gaze analysis may be performed based on this information to determine how the user consumes the mesh video, how long the user is looking at a particular area of the mesh video, and the like. The gaze analysis may be performed on the receiving side and the result may be delivered to the transmitting side through a feedback channel. A device, such as a VR/AR/MR display, may extract a viewport area based on the user's head position/orientation, the vertical or horizontal FOV supported by the device, etc.

In some embodiments, the feedback information described above may not only be delivered to the transmitter, but may also be consumed on the receiving side. In other words, operations such as decoding and rendering may be performed on the receiving side based on the feedback information described above. For example, based on the head orientation information and/or viewport information, only the mesh video for the area currently being viewed by the user may be preferentially decoded and rendered.

The present disclosure relates to embodiments of dynamic mesh video compression as described above. The methods/embodiments disclosed herein may be applied to the standard of Video-based Dynamic mesh compression (V-Mesh) of the Moving Picture Experts Group (MPEG) or any next-generation video/image coding standard. Dynamic mesh video compression is a method for processing mesh connectivity information and attributes that change over time. It may perform lossy and lossless compression for a variety of applications such as real-time communications, storage, free-viewpoint video, and AR/VR.

The dynamic mesh video compression method described below is based on the V-mesh method of the MPEG.

In the present disclosure, a picture/frame may generally refer to a unit that represents one image at a specific time.

A pixel or pel may refer to the smallest unit that constitutes a picture (or video). Additionally, the term “sample” may be used as a term corresponding to a pixel. A sample may generally indicate a pixel or the value of the pixel in general. It may indicate only the pixel/pixel value of the luma component, or may indicate only the pixel/pixel value of the chroma component, or may indicate only the pixel/pixel value of the depth component.

A unit may represent the basic unit of image processing. The unit may include at least one of a specific area of the picture and information related to the region. In some cases, the term unit may be used interchangeably with terms such as block or area. In general, an M×N block may include a set (or array) of samples (or a sample array) or transform coefficients composed of M columns and N rows.

As described above, the encoding process of FIG. 1 is performed as follows.

In other words, the compression method of Video-based dynamic mesh compression (V-Mesh) may provide a method of compressing dynamic mesh video data based on 2D video codecs such as High Efficiency Video Coding (HEVC) and Versatile Video Coding (VVC). In the V-Mesh compression process, the following data is received as input and compressed.

Input mesh: Includes 3D coordinates of the vertices comprising the mesh, normal information about each vertex, mapping information for mapping the surface of the mesh to a 2D plane, and connectivity between the vertices constituting the surface. The surface of the mesh may be represented by triangles or other polygons, and the connectivity information between the vertices constituting the surface is stored according to a predetermined shape. The input mesh may be stored in the OBJ file format.

Attribute map (Texture map is also used interchangeably hereafter): Contains information about the attributes (color, normals, displacements, etc.) of a mesh and stores the data in the form of a mapping of the surface of the mesh onto a 2D image. Mapping indicating which part (surface or vertex) of the mesh corresponds to each piece of data in the attribute map is based on the mapping information contained in the input mesh. Since the attribute map has data about each frame of the mesh video, it may also be referred to as an attribute map video. The attribute map in the V-Mesh compression method mainly contains the color information about the mesh and is stored in an image file format (PNG, BMP, etc.).

Material library file: Contains the material attribute information used in the mesh, specifically the information that links the input mesh to the corresponding attribute map. It is stored in the Wavefront Material Template Library (MTL) file format.

In the V-Mesh compression method, the following data and information may be generated through the compression process.

Base mesh: Represents the objects in the input mesh using the minimum vertices determined according to the user's criteria by decimating the input mesh through the pre-processing process.

Displacement: Displacement information used to represent the input mesh as similarly as possible using the base mesh, expressed in 3D coordinates.

Atlas information: Metadata needed to reconstruct a mesh using the base mesh, displacement, and attribute map information. It may be generated and utilized in sub-units (sub-mesh, patch, etc.) that constitute the mesh.

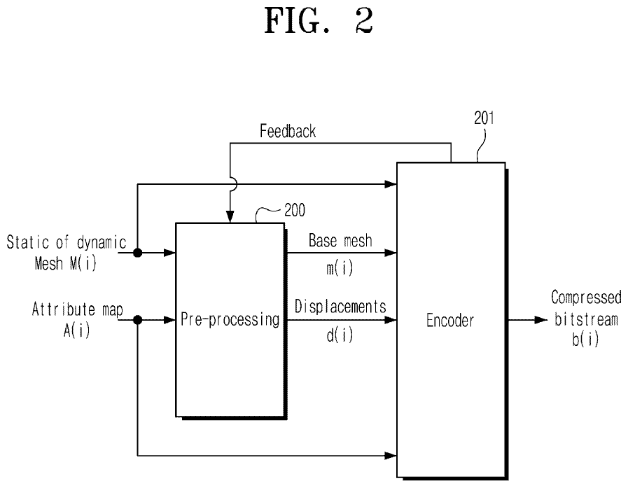

A method of encoding mesh position information (or vertex position information) is described with reference to FIGS. 2 to 7, and a method of reconstructing mesh position information to encode attribute information (attribute map) is described with reference to FIGS. 6 to 10 and the like.

FIG. 2 illustrates a V-MESH compression method according to embodiments.

FIG. 2 illustrates the encoding process of FIG. 1, wherein the encoding process may include a pre-processing process and an encoding process. The mesh video encoder 102 of FIG. 1 may include a pre-processor 200 and an encoder 201, as shown in FIG. 2. Also, the transmission apparatus of FIG. 1 may be broadly referred to as an encoder, and the mesh video encoder 102 of FIG. 1 may be referred to as an encoder. The V-Mesh compression method may include pre-processing 200 and encoding 201, as shown in FIG. 2. The pre-processor 200 of FIG. 2 may be positioned at the front end of the encoder 201 of FIG. 2. The pre-processor 200 and encoder 201 of FIG. 2 may be referred to as a single encoder.

The pre-processor 200 may receive a static of dynamic mesh (M(i)) and/or an attribute map (A(i)). The pre-processor 200 may generate a base mesh m(i) and/or displacements d(i) through pre-processing. The pre-processor 200 may receive feedback information from the encoder 201, and may generate the base mesh and/or displacements based on the feedback information.

The encoder 201 may receive the base mesh m(i), the displacements d(i), the static of dynamic mesh M(i), and/or the attribute map A(i). In the present disclosure, at least one of the base mesh m(i), the displacements d(i), the static of dynamic mesh M(i), and/or the attribute map A(i) may be referred to herein as mesh-related data. The encoder 201 may encode the mesh-related data to generate a compressed bitstream.

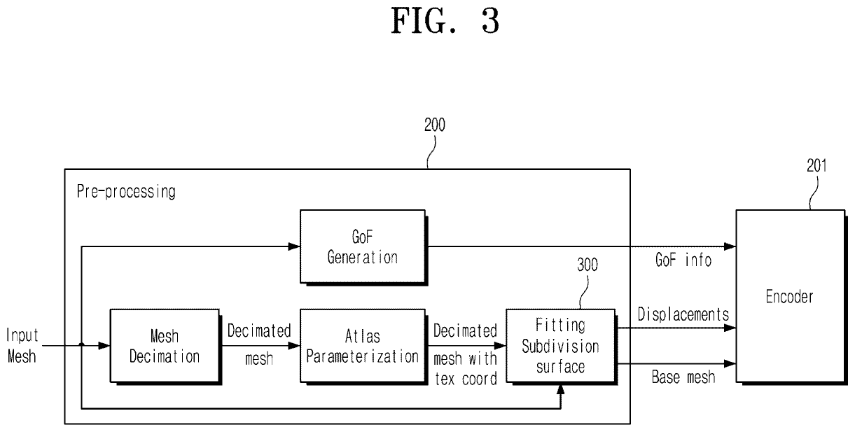

FIG. 3 illustrates pre-processing in V-MESH compression according to embodiments.

FIG. 3 illustrates the configuration and operation of the pre-processor of FIG. 2. In FIG. 3, the input mesh may include a static of dynamic mesh M(i) and/or attribute map A(i). The input mesh may also include 3D coordinates of vertices constituting the mesh, normal information about each vertex, mapping information for mapping the mesh surface to a 2D plane, and connectivity information between the vertices constituting the surface.

FIG. 3 illustrates the process of performing pre-processing on the input mesh. The pre-processing 200 may include four operations: 1) Group of Frame (GoF) generation, 2) mesh decimation, 3) UV parameterization, and 4) fitting subdivision surface (300). According to embodiments, the GoF generation may be referred to as a GoF generation process or a GoF generator, the mesh decimation may be referred to as a mesh simplification process or the mesh decimation part, the UV parameterization may be referred to as a UV parameterization process or the UV parameterization part, and the fitting subdivision surface may be referred to as a fitting subdivision surface process or a fitting subdivision surface part. The pre-processor 200 may generate displacements and/or a base mesh from the received input mesh, and deliver the same to the encoder 201. The pre-processor 200 may deliver GoF information related to the GoF generation to the encoder 201.

Hereinafter, each operation of FIG. 3 is described.

GoF generation: A process of generating a reference structure for the mesh data. When the mesh of the previous frame and the current mesh have the same number of vertices, same number of texture coordinates, same vertex connectivity information, and same texture coordinate connectivity information, the previous frame may be set as a reference frame. In other words, if only the vertex coordinate values are different between the current input mesh and the reference input mesh, the encoder 201 may perform inter frame encoding. Otherwise, it performs intra frame encoding for the frame.

Mesh decimation: A process of simplifying the input mesh to create a simplified mesh, called a base mesh. Vertices to remove may be selected from the original mesh based on user-defined criteria, and then the selected vertices and the triangles connected to the selected vertices may be removed.

In the process of performing mesh decimation, the voxelized input mesh, target triangle ratio (TTR), and minimum triangle component (CCCount) information may be delivered as input, and the decimated mesh may be obtained as output. In the process, connected triangle components that are smaller than the set minimum triangle component (CCCount) may be removed.

UV parameterization: A process of mapping a 3D curved surface into a texture domain for the decimated mesh. Parameterization may be performed using the UVAtlas tool. This process generates mapping information indicating where each vertex of the decimated mesh may be mapped to on the 2D image. The mapping information is expressed and stored as texture coordinates, and the final base mesh is generated through this process.

Fitting subdivision surface (300): A process of performing subdivision on the decimated mesh (i.e., a decimated mesh with texture coordinates). The displacements and base mesh generated by this process are output to the encoder 201. A user-defined method, such as the mid-edge method, may be applied as the subdivision method. A fitting process is performed such that the input mesh and the subdivided mesh become similar to each other. The mesh on which the fitting process is performed will be referred to herein as the fitted subdivided mesh.

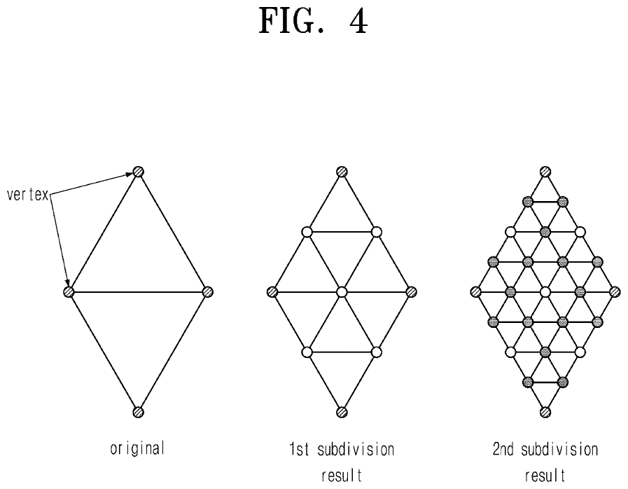

FIG. 4 illustrates a mid-edge subdivision method according to embodiments.

FIG. 4 illustrates a mid-edge subdivision method for the fitting subdivision surface described with reference to FIG. 3. Referring to FIG. 4, the original mesh containing four vertices is subdivided to create sub-meshes. The sub-meshes may be created by creating new vertices in the middle of the edges between the vertices. Then, the fitting process is performed to make the input mesh and the sub-mesh similar to each other, resulting in a fitted subdivided mesh.

Once the fitted subdivided mesh is generated, the displacements are calculated based on this result and the previously compressed and decoded base mesh (hereinafter referred to as the reconstructed base mesh). In other words, the reconstructed base mesh is subdivided in the same way as the fitting subdivision surface. The difference in position between this result and each vertex in the fitted subdivided mesh is the displacement for each vertex. Since the displacement represents a difference in position in 3D space, it is expressed as values in (x, y, z) space in the Cartesian coordinate system. Depending on a user input parameter, the coordinate values of (x, y, z) may be converted to coordinate values of (normal, tangential, bi-tangential) in a local coordinate system.

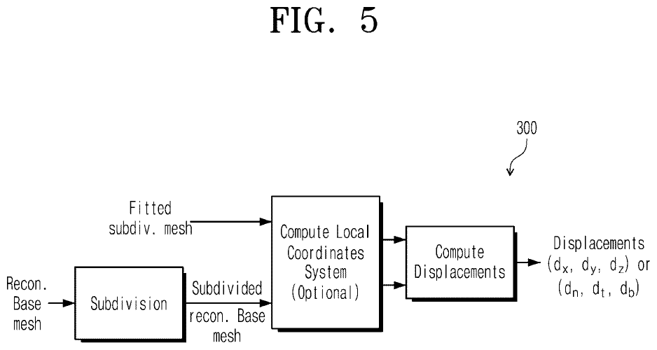

FIG. 5 illustrates a displacement generation process according to embodiments. The displacement generation process of FIG. 5 may be performed by the pre-processor 200, or may be performed by the encoder 201.

FIG. 5 illustrates in detail how displacements are calculated for the fitting subdivision surface 300, as described with reference to FIG. 4.

The encoder and/or pre-processor according to the embodiments may include 1) a subdivider, 2) a local coordinate system calculator, and 3) a displacement vector calculator. The subdivider may perform a subdivision on the reconstructed base mesh to generate a subdivided reconstructed base mesh. Here, the reconstruction of the base mesh may be performed by the pre-processor 200, or may be performed by the encoder 201. The local coordinate system calculator may receive the fitted subdivided mesh and the subdivided reconstructed base mesh, and may transform the coordinate system related to the mesh to a local coordinate system based on the received meshes. The local coordinate system calculation may be optional. The displacement calculator calculates the difference in position between the fitted subdivision mesh and the subdivided reconstructed base mesh. For example, it may generate the difference in position between the vertices in the two input meshes. The difference in position between the vertices is the displacement.

The mesh data transmission method and apparatus according to embodiments may encode the mesh data as follows. Mesh data is a term that includes point cloud data. Point cloud data (which may be referred to as a point cloud for short) according to embodiments may refer to data including vertex coordinates (also referred to as geometry information) and color information (also referred to as attribute information). In addition, a geometry image, an attribute image, an occupancy map, and auxiliary information (also referred to as patch information) generated through patch generation and packing based on vertex coordinates and color information may also be referred to as point cloud data. Therefore, point cloud data including connectivity information may be referred to as mesh data. The terms point cloud and mesh data may be used interchangeably herein.

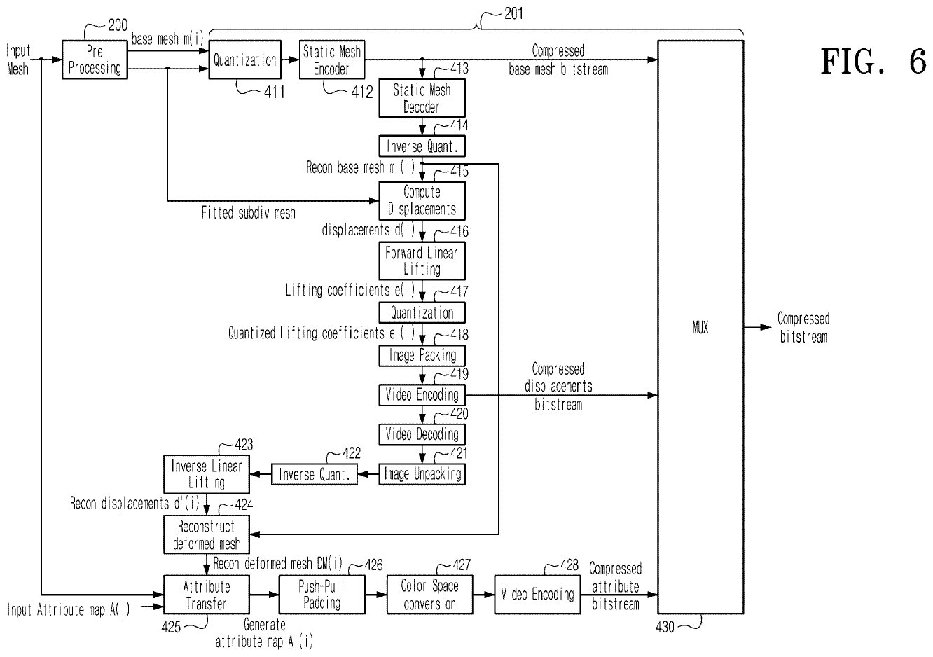

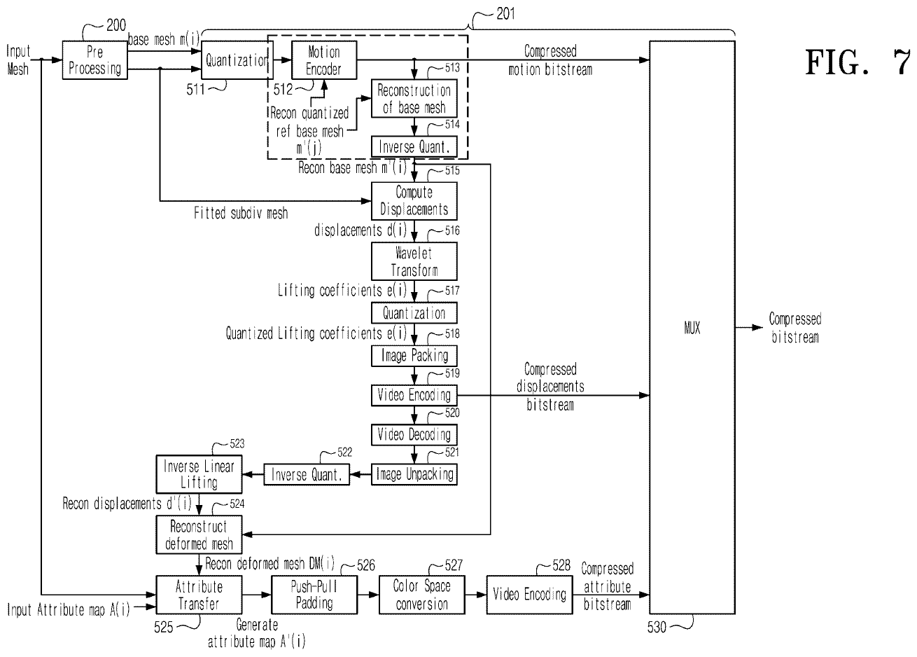

According to embodiments, the V-Mesh compression (reconstruction) method may include intra frame encoding (FIG. 6) and inter frame encoding (FIG. 7).

Based on the results of the GoF generation described above, intra frame encoding or inter frame encoding is performed. In the intra encoding, the data to be compressed may be a base mesh, displacements, an attribute map, and the like. In the inter encoding, the data to be compressed may be displacements, an attribute map, and a motion field between the reference base mesh and the current base mesh.

FIG. 6 illustrates an intra-frame encoding process in a V-MESH compression method according to embodiments. Each component for the intra-frame encoding process of FIG. 6 corresponds to hardware, software, a processor, and/or a combination thereof.

The encoding process of FIG. 6 details the encoding of the mesh video encoder 102 of FIG. 1. That is, it represents the configuration of the mesh video encoder 102 when the encoding of FIG. 1 is intra-frame encoding. The encoder of FIG. 6 may include a pre-processor 200 and/or an encoder 201. The pre-processor 200 and encoder 201 of FIG. 6 may correspond to the pre-processor 200 and encoder 201 of FIG. 3.

The pre-processor 200 may receive an input mesh and perform the pre-processing described above. A base mesh and/or a fitted subdivided mesh may be generated through the pre-processing.

The quantizer 411 of the encoder 201 may quantize the base mesh and/or the fitted subdivided mesh. The static mesh encoder 412 may encode the static mesh (i.e., the quantized base mesh) and generate a bitstream containing the encoded base mesh (i.e., a compressed base mesh bitstream). The static mesh decoder 413 may decode the encoded static mesh (i.e., the encoded base mesh). The inverse quantizer 414 may inversely quantize the quantized static mesh (i.e., base mesh) and output a reconstructed (restored) base mesh. The displacement calculator 415 may generate a displacement or displacements based on the reconstructed static mesh (i.e., base mesh) and the fitted subdivided mesh. According to embodiments, the displacement calculator 415 subdivides the reconstructed base mesh and then calculates a displacement, which is the difference in position of each vertex between the subdivided base mesh and the fitted subdivided mesh. In other words, the displacement is a displacement vector that is the difference in position between the vertices in the two meshes when the fitted subdivided mesh is similar to the original mesh. The forward linear lifter 416 may perform a lifting transform on the input displacements to generate lifting coefficients (also referred to as a transform coefficient). The quantizer 417 may quantize the lifting coefficients. The image packer 418 may pack the image based on the quantized lifting coefficients. The video encoder 419 may encode the packed image. That is, the quantized lifting coefficients are packed into a frame as a 2D image by the image packer 418, compressed by the video encoder 419, and output as a displacement bitstream (i.e., a compressed displacement bitstream).

The video decoder 420 decodes the compressed displacement bitstream. The image unpacker 421 may perform unpacking on the decoded displacement frame to output quantized lifting coefficients. The inverse quantizer 422 may inversely quantize the quantized lifting coefficients. The inverse linear lifting unit 423 applies inverse lifting to the inversely quantized lifting coefficients to generate reconstructed displacements. The mesh reconstructor 424 restores the reconstructed and deformed mesh based on the reconstructed displacements output from the inverse linear lifting unit 423 and the reconstructed base mesh (also referred to as the subdivided reconstructed base mesh) output from the inverse quantizer 414. The reconstructed and deformed mesh is referred to herein as the reconstructed deformed mesh.

The attribute transfer 425 receives an input mesh and/or an input attribute map and regenerates an attribute map based on the reconstructed deformed mesh. The attribute map refers to a texture map corresponding to attribute information among the mesh data components. In the present disclosure, the terms attribute map and texture map may be used interchangeably. The push-pull padding unit 426 may pad data to the attribute map based on a push-pull method. The color space converter 427 may convert the space of the color components of the attribute map. For example, the attribute map may be converted from an RGB color space to a YUV color space. The video encoder 428 may encode the attribute map to output a compressed attribute bitstream.

The multiplexer 430 may multiplex the compressed base mesh bitstream, the compressed displacement bitstream, and the compressed attribute bitstream to generate a compressed bitstream.

In FIG. 6, the displacement calculator 415 may be included in the pre-processor 200. Additionally, at least one of the quantizer 411, the static mesh encoder 412, the static mesh decoder 413, or the inverse quantizer 414 may be included in the pre-processor 200.

As described in FIG. 6, the intra frame encoding method includes base mesh encoding (also referred to as static mesh encoding). That is, when intra frame encoding is performed on the current input mesh frame, the base mesh generated during the pre-processing of the pre-processor 200 may be quantized by the quantizer 411 and then encoded by the static mesh encoder 412 using a static mesh compression technique. In the V-Mesh compression method, for example, the Draco technique is applied to encode the base mesh, and the vertex position information, mapping information (texture coordinates), vertex connectivity information, and the like related to the base mesh are subject to compression.

The encoder in FIG. 6 compresses the base mesh, displacements, and attributes in a frame to generate a bitstream, while the encoder in FIG. 7 compresses the motion, displacements, and attributes between the current frame and a reference frame to generate a bitstream.

FIG. 7 illustrates an inter-frame encoding process in a V-MESH compression method according to embodiments. Each component for the inter-frame encoding process of FIG. 7 corresponds to hardware, software, a processor, and/or a combination thereof.

The encoding process of FIG. 7 details the encoding of FIG. 1 in detail. That is, it represents the configuration of the encoder when the encoding of FIG. 1 is inter-frame encoding. The encoder of FIG. 7 may include a pre-processor 200 and/or an encoder 201. The pre-processor 200 and encoder 201 of FIG. 7 may correspond to the pre-processor 200 and encoder 201 of FIG. 3.

For the components of the encoding operation of FIG. 7 that correspond to the encoding operation of FIG. 6, refers to the description of FIG. 6. That is, the operations of the quantizer 511, displacement calculator 515, wavelet transformer 516, quantizer 517, image packer 518, video encoder 519, video decoder 520, image unpacker 521, inverse quantizer 522, and inverse wavelet transformer 523, mesh reconstructor 524, attribute transfer 525, push-pull padding 526, color space converter 527, video encoder 528, and multiplexer 530 in FIG. 7 are the same as or similar to the operations of the quantizer 411, static mesh encoder 412, static mesh decoder 413, and inverse quantizer 414, displacement calculator 415, forward linear lifting unit 416, quantizer 417, image packer 418, video encoder 419, video decoder 420, image unpacker 421, inverse quantizer 422, inverse linear lifting unit 423, and mesh reconstructor 424, attribute transfer 425, push-pull padding 426, color space converter 427, video encoder 428, and multiplexer 430 in FIG. 6 described above, and are therefore not described in detail in relation to FIG. 7 to avoid redundancy.

In FIG. 7, for inter-frame-based encoding, the motion encoder 512 may obtain and encode a motion vector between the reconstructed quantized reference base mesh and the quantized current base mesh, and output a compressed motion bitstream. The motion encoder 512 may be referred to as a motion vector encoder. The base mesh reconstructor 513 may reconstruct a base mesh based on the reconstructed quantized reference base mesh and the encoded motion vectors. The reconstructed base mesh is inversely quantized by the inverse quantizer 514 and output to the displacement calculator 515.

In FIG. 7, the displacement calculator 515 may be included in the pre-processor 200. Additionally, at least one of the quantizer 511, motion encoder 512, base mesh reconstructor 513, or inverse quantizer 514 may be included in the pre-processor 200.

As described with reference to FIG. 7, the inter-frame encoding method may include motion field encoding (also referred to as motion vector encoding). Inter frame encoding may be performed when the reference mesh and the current input mesh have a one-to-one correspondence of vertices, and only the position information about the vertices differs therebetween. When inter frame encoding is performed, the base mesh may not be compressed. Instead, the difference between the vertices of the reference base mesh and the current base mesh, i.e., the motion field (or motion vector) may be computed and encoded. The reference base mesh is the result of quantizing the decoded base mesh data and is determined by the reference frame index determined in the GoF generation. The motion field may be encoded as it is. Alternatively, a predicted motion field may be calculated by averaging the motion fields of the reconstructed vertices among the vertices connected to the current vertex, and a residual motion field, which is the difference between the value of the predicted motion field and the value of the motion field of the current vertex, may be encoded. The value of the residual motion field may be encoded using entropy coding. Except for the motion field encoding in the inter frame encoding, the process of encoding the displacements and attribute map is the same as the structure of the intra frame encoding method except for the base mesh encoding.

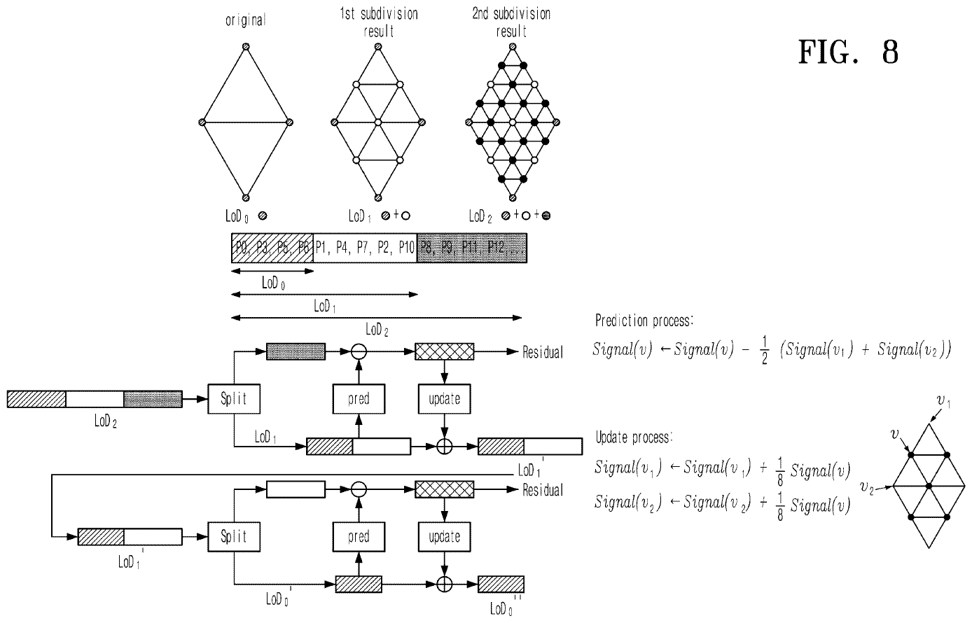

FIG. 8 illustrates a lifting transform process for displacements according to embodiments.

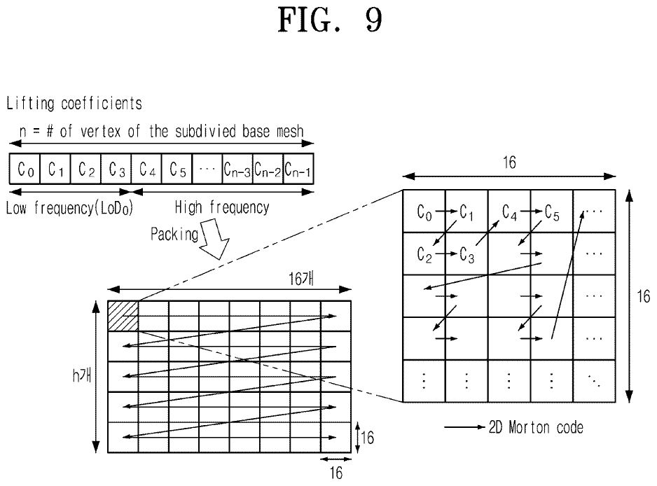

FIG. 9 illustrates a process of packing transform coefficients (also referred to as lifting coefficients) into a 2D image according to embodiments.

FIGS. 8 and 9 illustrate the process of transforming displacements and packing transform coefficients in the encoding process of FIGS. 6 and 7, respectively.

An encoding method according to the embodiments includes displacement encoding.

After base mesh encoding and/or motion field encoding, a reconstructed base mesh may be generated through reconstruction and inverse quantization, and a displacement may be calculated between a result of subdivision of the reconstructed base mesh and a fitted subdivided mesh generated through the fitting subdivision surface (see 415 in FIG. 6 or 515 in FIG. 7). A data transform process, such as a wavelet transform, may be applied to the displacement information for effective encoding (see 416 in FIG. 6, or 516 in FIG. 7).

FIG. 8 illustrates the process of transforming displacement information by the forward linear lifting unit 416 of FIG. 6 or the wavelet transformer 516 of FIG. 7 using the lifting transform. For example, a linear wavelet-based lifting transform may be performed. The transform coefficients generated through the transform process are quantized by the quantizer 417 (or 517) and then packed into a 2D image by the image packer 418 (or 518), as shown in FIG. 9. The transform coefficients may be organized into blocks, one block for every 256 (=16×16) units. Each block may be packed in a z-scan order. The number of rows in a block is fixed to 16, but the number of columns in the block may be determined by the number of vertices in the subdivided base mesh. Within a block, the transform coefficients may be sorted with the Morton code and packed. For the packed images, a displacement video may be generated per GoF. The displacement video may be encoded by the video encoder 419 (or 519) using a conventional video compression codec.

Referring to FIG. 8, the base mesh (original) may include vertices and edges for LoD0. A first subdivision mesh generated by splitting (or subdividing) the base mesh includes vertices generated by further splitting (or subdividing) the edges of the base mesh. The first subdivision mesh contains vertices for LoD0 and vertices for LoD1. LoD1 includes subdivided vertices and vertices from the base mesh (LoD0). The first subdivision mesh may be split (or subdivided) to generate a second subdivision mesh. The second subdivision mesh contains LoD2. LoD2 includes a base mesh vertex (LoD0), LoD1 containing vertices further split (or subdivided) from LoD0, and LoD2 containing vertices further split (or subdivided) from LoD1. LoD is a level of detail that indicates how detailed the mesh data content is. As the index of the level increases, the distance between vertices is shortened, and the level of detail rises. In other words, as the value of LoD decreases, the detail of the mesh data content is degraded. As the value of LoD increases, the detail of the mesh data content is enhanced. LoD N contains the vertices contained in LoD N-1. In the case where the mesh (or vertex) is further split through subdivision, the mesh may be encoded based on a prediction and/or updating method, taking into account the previous vertices v1 and v2, and the subdivided vertex v. Instead of encoding the information for the current LoD N as it is, a residual with respect to previous LoD N-1 may be generated. Thus, the mesh may be encoded using the residual to reduce the size of the bitstream. The prediction process refers to the operation of predicting the current vertex v from the previous vertices v1 and v2. Since neighboring subdivision meshes have similar data, this property may be exploited for efficient encoding. The current vertex position information is predicted from the residual for the previous vertex position information, and the previous vertex position information is updated through the residual. In the present disclosure, vertex and point may be used interchangeably. The LoDs may be defined in the subdivision of the base mesh. According to embodiments, the subdivision of the base mesh may be performed by the pre-processor 200 or may be performed by a separate component/module.

Referring to FIG. 9, a vertex has a transform coefficient (also referred to as a lifting coefficient) generated through lifting transform. The transform coefficient of the vertex related to the lifting transform may be packed into an image by the image packer 418 (or 518) and then encoded by the video encoder 419 (or 519).

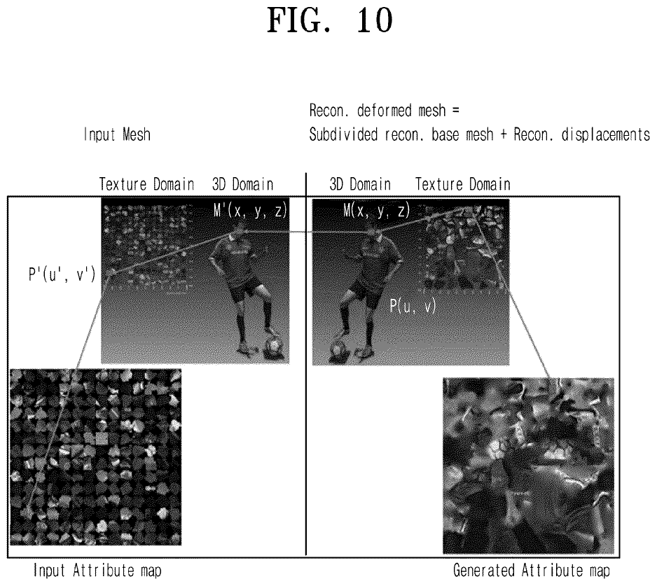

FIG. 10 illustrates an attribute transfer process in a V-MESH compression method according to embodiments.

According to embodiments, FIG. 10 illustrates a detailed operation of the attribute transfer 425 (or 525) in the encoding of FIGS. 6, 7, etc.

The encoding according to the embodiments includes attribute map encoding. According to embodiments, the attribute map encoding may be performed by the video encoder 428 of FIG. 6 or the video encoder 528 of FIG. 7.

According to embodiments, in the present disclosure, the encoder compresses information about the input mesh through base mesh encoding (i.e., intra-encoding), motion field encoding (i.e., inter-encoding), and displacement encoding. The input mesh compressed in the encoding process is reconstructed through base mesh decoding (intra frame), motion field decoding (inter frame), and displacement video decoding, and the reconstructed deformed mesh (hereinafter referred to as Recon. deformed mesh), which is the result of the reconstruction, is used to compress the input attribute map, as shown in FIGS. 6 and 7. The Recon. deformed mesh has position information about vertices, texture coordinates, and corresponding connectivity information, but does not have color information corresponding to the texture coordinates. Therefore, as shown in FIG. 10, in the V-Mesh compression method, a new attribute map having color information corresponding to the texture coordinates of the recon. deformed mesh is re-generated through the attribute transfer process of the attribute transfer 425 (or 525).

According to embodiments, the attribute transfer 425 (or 525) first checks, for every point P(u, v) in the 2D texture domain, whether the corresponding vertex is within a texture triangle of the Recon. deformed mesh. When the corresponding vertex is in the texture triangle T, the attribute transfer calculates the barycentric coordinates (α, β, γ) of P(u, v) according to the triangle T. Then, it calculates the 3D coordinates M(x, y, z) of P(u, v) based on the 3D vertex positions of the triangle T and (α, β, γ). The vertex coordinates M′(x′, y′, z′) that corresponds to the closest position to the calculated M(x, y, z) and a triangle T′ containing this vertex are searched for in the input mesh domain. Then, the barycentric coordinates (α′, β′, γ′) of M′(x′, y′, z′) in the triangle T′ are calculated. The texture coordinates (u′, v′) are calculated based on the texture coordinates corresponding to the three vertices of triangle T′ and (α′, β′, γ′), and the color information corresponding to the coordinates are searched for in the input attribute map. The color information found in this way is then assigned to the (u, v) pixel position in the new input attribute map. If P(u, v) does not belong to any triangle, the pixel at the position in the new input attribute map be filled with a color value using a padding algorithm, such as the push-pull algorithm of the push-pull padding 426 (or 526).

The new attribute map generated by the attribute transfer 425 (or 525) is bundled into GoFs to construct an attribute map video, which is compressed using a video codec of the video encoder 428 (or 528).

A reference relationship between the input mesh, the input attribute map, the reconstructed deformed mesh, and the reconstructed attribute map is shown may be seen from FIG. 10.

The decoding process of FIG. 1 may perform the reverse of the encoding process of FIG. 1. Specifically, the decoding process is performed as disclosed below.

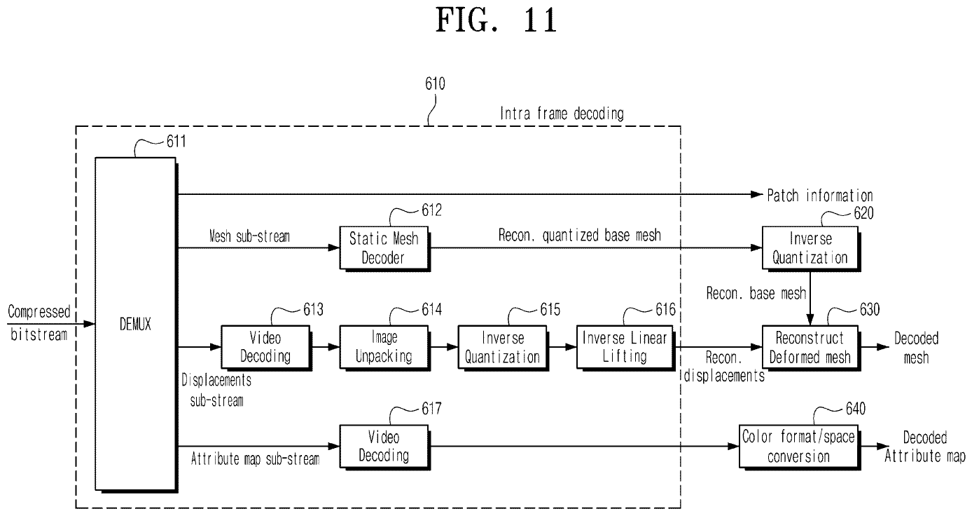

FIG. 11 shows the intra-frame decoding (or intra decoding) process of the V-Mesh technology according to embodiments.

FIG. 11 illustrates the configuration and operation of the mesh video decoder 113 of the reception apparatus of FIG. 1. Additionally, FIG. 11 illustrates that the mesh data may be reconstructed by performing a reverse process to the intra-frame encoding process of FIG. 6. Each component for the intra-frame decoding process of FIG. 11 corresponds to hardware, software, and/or a combination thereof.

First, the bitstream (i.e., compressed bitstream) received and input to the demultiplexer 611 of the intra-frame decoder 610 may be separated into a mesh sub-stream, a displacement sub-stream, an attribute map sub-stream, and a sub-stream containing patch information about the mesh, such as V-PCC/V3C. The term V-PCC (Video-based Point Cloud Compression) used in the present disclosure may have the same meaning as V3C (Visual Volumetric Video-based Coding). The two terms may be used interchangeably. Accordingly, in the present disclosure, the term V-PCC may be interpreted as V3C.

According to embodiments, the mesh sub-stream may be input to and decoded by a static mesh decoder 612, the displacement sub-stream may be input to and decoded by the video decoder 613, and the attribute map sub-stream may be input to and decoded by the video decoder 617.

According to embodiments, the mesh sub-stream may be decoded through the decoder 612 of a static mesh codec used in the encoding such as, for example, Google Draco, to reconstruct connectivity information, vertex geometry information, vertex texture coordinates, and the like related to the result of the decoding, a recon. quantized base mesh, e.g., reconstructed base mesh.

According to embodiments, the displacement sub-stream may be decoded into a displacement video through the decoder 613 of the video compression codec used in the encoding. Then, image unpacking is performed by the image unpacker 614, inverse quantization is performed by the inverse quantizer 615, and inverse transform is performed by the inverse linear lifting unit 616 to reconstruct the displacement information about each vertex (i.e., Recon. displacements).

According to embodiments, the base mesh reconstructed by the static mesh decoder 612 is inversely quantized by the inverse quantizer 620 and output to the mesh reconstructor 630. The mesh reconstructor 630 reconstructs a reconstructed deformed mesh (i.e., a decoded mesh) based on the reconstructed displacements output from the inverse linear lifting unit 616 and the reconstructed base mesh output from the inverse quantizer 620. In other words, the inversely quantized reconstructed base mesh is combined with the reconstructed displacement information to generate a final decoded mesh. In the present disclosure, the final decoded mesh is referred to as a reconstructed deformed mesh.

According to embodiments, the attribute map sub-stream is decoded by the decoder 617 corresponding to the video compression codec used in the encoding, and then a final attribute map (i.e., a decoded attribute map) is reconstructed by the color transformer 640 through color format transform, color space conversion, and the like.

According to embodiments, the reconstructed decoded mesh and decoded attribute map may be utilized at the receiving side as final mesh data that may be utilized by a user.

Referring to FIG. 11, the received compressed bitstream includes patch information, a mesh sub-stream, a displacement sub-stream, and an attribute map sub-stream. The term sub-stream is interpreted as referring to a partial bitstream included in the bitstream. The bitstream contains patch information (data), mesh information (data), displacement information (data), and attribute map information (data).

As described above, the decoder of FIG. 11 performs intra-frame decoding as follows. The static mesh decoder 612 decodes the mesh sub-stream to generate a reconstructed quantized base mesh, and the inverse quantizer 620 applies the quantization parameters of the quantizer in reverse to generate a reconstructed base mesh. The video decoder 613 decodes the displacement sub-stream, the image unpacker 614 unpacks the image of the decoded displacement video, and the inverse quantizer 615 inversely quantizes the quantized image. The inverse linear lifting unit 616 applies a lifting transform in the reverse process of the encoder to generate a reconstructed displacement. The mesh reconstructor 630 generates a reconstructed deformed mesh based on the reconstructed base mesh and the reconstructed displacement. The video decoder 617 decodes the attribute map sub-stream, and the color transformer 640 transforms the color format and/or space of the decoded attribute map to generate a decoded attribute map.

FIG. 12 illustrates an inter-frame decoding (or inter-decoding) process of V-Mesh technology.

FIG. 12 illustrates the configuration and operation of the mesh video decoder 113 of the reception apparatus of FIG. 1. In FIG. 12, mesh data may be reconstructed by performing a reverse process to the inter-frame encoding process of FIG. 7. Each component for the intra-frame decoding process of FIG. 12 corresponds to hardware, software, and/or a combination thereof.

First, the bitstream received and input to the demultiplexer 711 of the intra-frame decoder 710 may be separated into a motion sub-stream (also referred to as a motion vector sub-stream), a displacement sub-stream, an attribute map sub-stream, and a sub-stream containing patch information about the mesh, such as V3C/V-PCC.

According to embodiments, the motion sub-stream may be input to and decoded by the motion decoder 712, the displacement sub-stream may be input to and decoded by the video decoder 713, and the attribute map sub-stream may be input to and decoded by the video decoder 717.

According to embodiments, the motion sub-stream is decoded by the motion decoder 712 through entropy decoding and inverse prediction to reconstruct motion information (also referred to as motion vector information). The base mesh reconstructor 718 combines the reconstructed motion information with a pre-reconstructed and stored reference base mesh to generate a reconstructed quantized base mesh for the current frame. The inverse quantizer 720 applies inverse quantization to the reconstructed quantized base mesh to generate a reconstructed base mesh. The video decoder 713 decodes the displacement sub-stream, the image unpacker 714 unpacks the image of the decoded displacement video, and the inverse quantizer 715 inversely quantizes the quantized image. The inverse linear lifting unit 716 applies a lifting transform in the reverse process of the encoder to generate a reconstructed displacement. The mesh reconstructor 730 generates a reconstructed deformed mesh, i.e., a final decoded mesh, based on the reconstructed base mesh and the reconstructed displacement.

According to embodiments, the video decoder 717 decodes the attribute map sub-stream in the same way as the intra-decoding, and the color transformer 740 transforms the color format and/or space of the decoded attribute map to generate a decoded attribute map. The decoded mesh and decoded attribute map may be utilized at the receiving side as the final mesh data that may be utilized by the user.

Referring to FIG. 12, the bitstream contains motion information (also referred to as motion vectors), displacements, and an attribute map. The process of FIG. 12 further includes decoding the inter-frame motion information because inter-frame decoding is performed. A reconstructed base mesh is generated by decoding the motion information and generating a reconstructed quantized base mesh for the motion information based on the reference base mesh. For the operations in FIG. 12 that are the same as those in FIG. 11, refer to the description of FIG. 11.

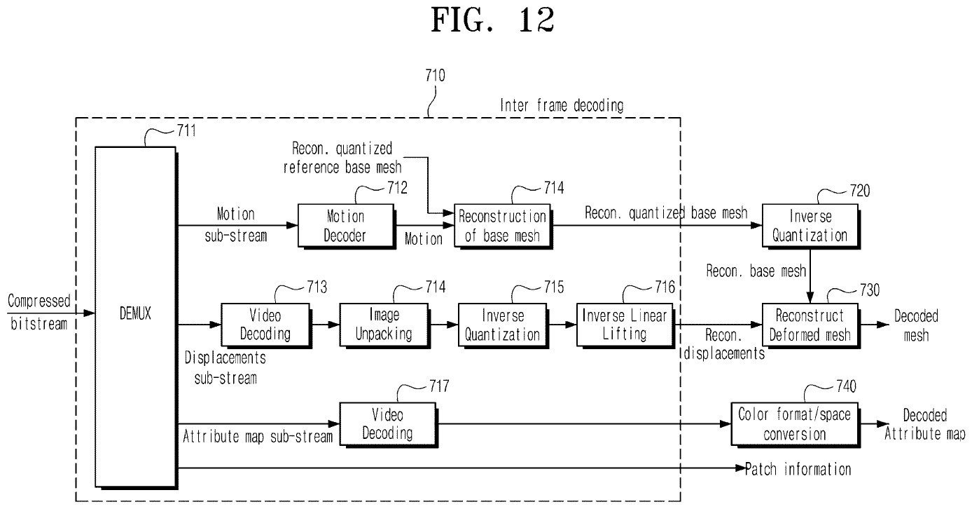

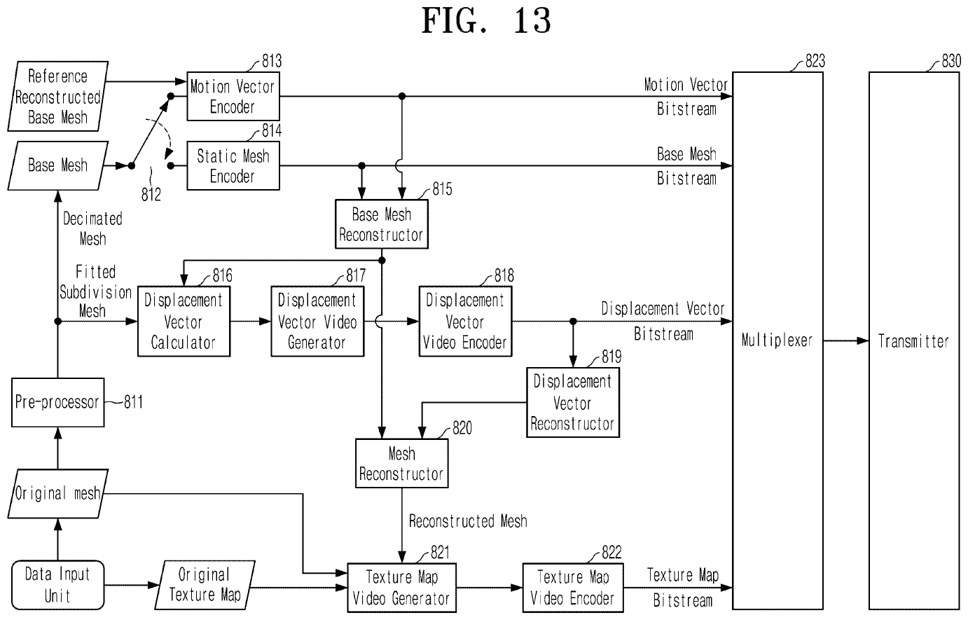

FIG. 13 illustrates a mesh data transmission apparatus according to embodiments.

FIG. 13 corresponds to the transmission apparatus 100 or mesh video encoder 102 of FIG. 1, the encoder (pre-processor and encoder) of FIGS. 2, 6, or 7, and/or the corresponding transmission encoding device. Each component of FIG. 13 corresponds to hardware, software, a processor, and/or a combination thereof.

The process of operations at the transmitting end for compressing and transmitting dynamic mesh data using a V-Mesh compression technique may be configured as shown in FIG. 13. The transmission apparatus of FIG. 13 may perform intra-frame encoding (also referred to as intra-encoding or intra-picture encoding) and/or inter-frame encoding (also referred to as inter-encoding or inter-picture encoding).

The pre-processor 811 receives the original mesh and generates a decimated mesh (or base mesh) and a fitted subdivided (or subdivision) mesh. The decimation may be performed based on a target number of vertices or a target number of polygons constituting the mesh. Parameterization may be performed on the decimated mesh to generate texture coordinates and texture connectivity information per vertex. For example, the parameterization is a process of mapping a 3D curved surface into a texture domain for the decimated mesh. When the parameterization is performed using the UVAtlas tool, mapping information indicating where each vertex of the decimated mesh may be mapped to on the 2D image is generated. The mapping information is expressed and stored as texture coordinates, and the final base mesh is generated through this process. The mesh information may be quantized from a floating-point form to a fixed-point form. The result is the base mesh, which may be output to a motion vector encoder 813 or a static mesh encoder 814 through a switching unit 812. The pre-processor 811 may perform a mesh subdivision on the base mesh to generate additional vertices. Depending on the subdivision method, vertex connectivity information including the additional vertices, texture coordinates, and connectivity information about the texture coordinates may be generated. The pre-processor 811 may generate a fitted subdivided mesh by adjusting vertex positions such that the subdivided mesh becomes similar to the original mesh.

According to embodiments, when inter-frame encoding (inter-encoding) is performed on the mesh frame, the base mesh is output to the motion vector encoder 813 through the switching unit 812. When intra-frame encoding (intra-encoding) is performed on the mesh frame, the base mesh is output to the static mesh encoder 814 through the switching unit 812. The motion vector encoder 813 may be referred to as a motion encoder.

For example, when intra-encoding (intra-frame encoding) is performed on the mesh frame, the base mesh may be compressed through the static mesh encoder 814. In this case, the connectivity information, vertex geometry information, vertex texture information, normal information, and the like related to the base mesh may be encoded. The base mesh bitstream generated through the encoding is transmitted to the multiplexer 823.

As another example, when inter-encoding (inter-frame encoding) is performed on the mesh frame, the motion vector encoder 813 may receive as input a base mesh and a reference reconstructed base mesh (or a reconstructed quantized reference base mesh), compute a motion vector between the two meshes, and encode the value thereof. Further, the motion vector encoder 813 may perform connectivity information-based prediction using the previously encoded/decoded motion vector as a predictor, and encode a residual motion vector, which is obtained by subtracting the predicted motion vector from the current motion vector. The motion vector bitstream generated by the encoding is transmitted to the multiplexer 823.

The base mesh reconstructor 815 may receive the base mesh encoded by the static mesh encoder 814 or the motion vector encoded by the motion vector encoder 813, and generate a reconstructed base mesh. For example, the base mesh reconstructor 815 may perform static mesh decoding on the base mesh encoded by the static mesh encoder 814 to reconstruct the base mesh. In this case, quantization may be applied before the static mesh decoding, and inverse quantization may be applied after the static mesh decoding. In another example, the base mesh reconstructor 815 may reconstruct the base mesh based on the reconstructed quantized reference base mesh and the motion vector encoded by the motion vector encoder 813. The reconstructed base mesh is output to the displacement calculator (or displacement vector calculator) 816 and the mesh reconstructor 820.

The displacement calculator 816 may perform mesh subdivision on the reconstructed base mesh. The displacement calculator 816 may calculate a displacement vector, which is the value of the difference in vertex positions between the subdivided reconstructed base mesh and the fitted subdivision (or subdivided) mesh generated by the pre-processor 811. In this case, displacement vectors as many as vertices in the subdivided mesh may be calculated. The displacement calculator 816 may transform the displacement vectors calculated in the 3D Cartesian coordinate system to a local coordinate system based on the normal vector of each vertex.

The displacement vector video generator 817 may include a linear lifting part, a quantizer, and an image packer. That is, in displacement vector video generator 817, the linear lifting unit may transform the displacement vectors for effective encoding. According to embodiments, the transform may be lifting transform, wavelet transform, or the like. In addition, the quantizer may perform quantization on the transformed displacement vector values, i.e., the transform coefficients. In this case, different quantization parameters may be applied to the axes of the transform coefficients, respectively. The quantization parameters may be derived by an agreement between the encoder/decoder. After transform and quantization, the displacement vector information may be packed into a 2D image by the image packer. The displacement vector video generator 817 may generate a displacement vector video by grouping the packed 2D images for each frame. A displacement vector video may be generated for each group of frames (GoF) of the input mesh.

The displacement vector video encoder 818 may encode the generated displacement vector video using a video compression codec. The generated displacement vector video bitstream is transmitted to the multiplexer 823.

The displacement vector reconstructor 819 may include a video decoder, an image unpacker, an inverse quantizer, and an inverse linear lifting part. That is, in the displacement vector reconstructor 819, the encoded displacement vector is decoded by the video decoder, image unpacking is performed by the image unpacker, inverse quantization is performed by the inverse quantizer, and inverse transform is performed by the inverse linear lifting unit to reconstruct displacement vectors. The reconstructed displacement vectors are output to the mesh reconstructor 820. The mesh reconstructor 820 reconstructs a deformed mesh based on the base mesh reconstructed by the base mesh reconstructor 815 and the displacement vectors reconstructed by the displacement vector reconstructor 819. The reconstructed mesh (also referred to as the reconstructed deformed mesh) has reconstructed vertices, inter-vertex connectivity information, texture coordinates, and inter-texture coordinate connectivity information.

The texture map video generator 821 may re-generate a texture map based on the texture map (or attribute map) of the original mesh and the reconstructed deformed mesh output from the mesh reconstructor 820. According to embodiments, the texture map video generator 821 may assign the vertex-by-vertex color information in the texture map of the original mesh to the texture coordinates of the reconstructed deformed mesh. According to embodiments, the texture map video generator 821 may generate a texture map video by grouping the frame-level re-generated texture maps into GoFs.

The generated texture map video may be encoded by the texture map video encoder 822 using a video compression codec. A texture map video bitstream generated through the encoding is transmitted to the multiplexer 823.

The multiplexer 823 multiplexes the motion vector bitstream (in the case of, for example, inter-encoding), the base mesh bitstream (in the case of, for example, intra-encoding), the displacement vector bitstream, and the texture map bitstream into a single bitstream. The single bitstream may be transmitted to the receiving side through the transmitter 824. Alternatively, for the motion vector bitstream, the base mesh bitstream, the displacement vector bitstream, and the texture map bitstream, a file with one or more track data may be generated or the bitstreams may be encapsulated into segments and transmitted to the receiving side through the transmitter 824.

Referring to FIG. 13, the transmitter (encoder) may encode the mesh in an intra-frame or inter-frame manner. According to intra-encoding, the transmission apparatus may generate a base mesh, displacement vectors (or displacements), and a texture map (or attribute map). According to inter-encoding, the transmission apparatus may generate a motion vector (or motion), displacement vectors (or displacements), and a texture map (or attribute map). The texture map acquired from the data input unit is generated and encoded based on the reconstructed mesh. The displacements are generated and encoded based on the differences in vertex positions between the base mesh and the segmented (or subdivided) mesh. More specifically, the displacement is a difference in position between the fitted subdivided mesh and the subdivided reconstructed base mesh, i.e., the difference in vertex position between the two meshes. The base mesh is generated by decimating the original mesh through pre-processing and encoding the decimated mesh. For the motion, a motion vector is generated for the mesh in the current frame based on the reference base mesh in the previous frame.

FIG. 14 illustrates a mesh data reception apparatus according to embodiments.

FIG. 14 corresponds to the reception apparatus 110 or mesh video decoder 113 of FIG. 1, the decoder of FIG. 11 or 12, and/or a corresponding reception decoding device. Each component of FIG. 14 corresponds to hardware, software, a processor, and/or a combination thereof. The reception (decoding) operation of FIG. 14 may follow a reverse process to the corresponding process of the transmission (encoding) operation of FIG. 13.

The bitstream of mesh data received by the receiver 910 is subjected to file/segment decapsulation and then demultiplexed by the demultiplexer 911 into a compressed motion vector bitstream (e.g., inter-decoding) or base mesh bitstream (e.g., intra-decoding), a displacement vector bitstream, and a texture map bitstream. For example, when the current mesh is inter-frame encoded (i.e., inter-encoded), the motion vector bitstream is received, demultiplexed, and then output to the motion vector decoder 913 through the switching unit 912. In another example, when the current mesh is intra-frame encoded (i.e., intra-encoded), the base mesh bitstream is received, demultiplexed, and output to the static mesh decoder 914 through the switching unit 912. Here, the motion vector decoder 913 may be referred to as a motion decoder.

According to embodiments, in the case where inter-frame encoding is applied to the current mesh based on the frame header information, the motion vector decoder 913 may decode the motion vector bitstream. According to embodiments, the motion vector decoder 913 may use the previously decoded motion vector as a predictor and add the same to the residual motion vector decoded from the bitstream to reconstruct the final motion vector.

According to embodiments, in the case where intra-frame encoding is applied to the current mesh based on the frame header information, the static mesh decoder 914 may decode the base mesh bitstream to reconstruct connectivity information, vertex geometry information, texture coordinates, normal information, and the like related to the base mesh.

According to embodiments, the base mesh reconstructor 915 may reconstruct the current base mesh based on the decoded motion vectors or the decoded base mesh. For example, in the case where inter-frame encoding is applied to the current mesh, the base mesh reconstructor 915 may add the decoded motion vectors to the reference base mesh and perform inverse quantization to generate a reconstructed base mesh. In another example, in the case where intra-frame encoding is applied to the current mesh, the base mesh reconstructor 915 may perform inverse quantization on the base mesh decoded by the static mesh decoder 914 to generate a reconstructed base mesh.

According to embodiments, the displacement vector video decoder 917 may decode the displacement vector bitstream as a video bitstream using a video codec.

According to embodiments, the displacement vector reconstructor 918 extracts displacement vector transform coefficients from the decoded displacement vector video, and applies inverse quantization and inverse transform to the extracted displacement vector transform coefficients to reconstruct displacement vectors. To this end, the displacement vector reconstructor 918 may include an image unpacker, an inverse quantizer, and an inverse linear lifting part. If the reconstructed displacement vectors are values in a local coordinate system, inverse transform to the Cartesian coordinate system may be performed.

The mesh reconstructor 916 may subdivide the reconstructed base mesh to generate additional vertices. Through the subdivision, vertex connectivity information including the additional vertices, texture coordinates, and connectivity information about the texture coordinates may be generated. In this case, the mesh reconstructor 916 may combine the subdivided reconstructed base mesh with the reconstructed displacement vectors to generate a final reconstructed mesh (also referred to as a reconstructed deformed mesh).

According to embodiments, the texture map video decoder 919 may decode the texture map bitstream as a video bitstream using a video codec to reconstruct a texture map. The reconstructed texture map has color information about each vertex in the reconstructed mesh, and the texture coordinates of each vertex may be used to obtain the color value of the vertex from the texture map.

According to embodiments, the mesh reconstructed from the mesh reconstructor 916 and the texture map reconstructed from the texture map video decoder 919 are presented to the user through a rendering process in the mesh data renderer 920.

Referring to FIG. 14, the reception apparatus (decoder) may decode the mesh in an intra-frame or inter-frame manner. According to intra-decoding, the reception apparatus may receive a base mesh, displacement vectors (or displacements), and a texture map (or attribute map), and render mesh data based on the reconstructed mesh and reconstructed texture map. According to inter-decoding, the reception apparatus may receive a motion vector (or motion), the displacement vectors (or displacements), a texture map (or attribute map), and render mesh data based on the reconstructed mesh and the reconstructed texture map.

A mesh data transmission apparatus and method according to embodiments may pre-process mesh data, encode the pre-processed mesh data, and transmit a bitstream containing the encoded mesh data. A point mesh data reception apparatus and method according to embodiments may receive a bitstream containing mesh data and decode the mesh data. The mesh data transmission/reception method/apparatus according to embodiments may be referred to as a method/apparatus according to embodiments. The mesh data transmission/reception method/apparatus may also be referred to as a 3D data transmission/reception method/apparatus or point cloud data transmission/reception method/apparatus.

As described above, the V-Mesh processing method performs subdivision on a simplified mesh (or base mesh or simplified mesh with texture coordinates) during the pre-processing process. For example, a sub-mesh may be generated by performing a subdivision process that generates a new vertex in the middle of edges between vertices. In this case, the number of vertices also increases according to a subdivision iteration count. In the present disclosure, vertex, apex, and point may be used with the same meaning. That is, a vertex has a coordinate in a 3D space, and a polygon of a triangle or a square may be generated through connections between a plurality of vertices. In the present disclosure, a surface of the polygon is called a face, and a line segment (or corner) connecting two vertices in the polygon is called an edge. A structure in which a plurality of line segments extend from one vertex is called a fan. That is, a fan unit is formed by line segments extending from a single vertex (i.e., the center point). In this case, line segments that constitute the fan unit function as an edge of the polygon. In the present disclosure, the fan unit may include one or more faces.

The V-Mesh processing method obtains a displacement vector based on a subdivided mesh. That is, a fitting process is performed to make an input mesh and sub-mesh similar to each other, and subdivision is performed on the generated fitted subdivision mesh and the reconstructed base mesh to calculate a difference in the position of each vertex of the generated subdivided reconstructed base mesh. In the present disclosure, a vertex position difference value is referred to as a displacement vector. In the present disclosure, the displacement vector may be used interchangeably with displacement or displacement information.

In the current subdivision process, the subdivision iteration count per frame or patch is determined to the same value. However, when the subdivision iteration count is determined on a frame-by-frame or patch-by-patch basis, the subdivision iteration count is the same for all frames or all patches, and thus the subdivision process may be performed on an area in which subdivision is unnecessary, and the displacement vector of the vertex generated thereby needs also to be transmitted. This leads to poor coding performance.

The present disclosure proposes an apparatus and method for adaptively deriving a subdivision iteration count of a dynamic mesh based on the mesh feature in a pre-processing operation to improve coding performance.

According to embodiments of the present disclosure, a subdivision iteration count may be differently determined for each subdivision iteration unit and a subdivision process of a mesh may be performed. When calculating the subdivision iteration count according to the subdivision iteration unit based on the mesh feature by using the same manner in an encoder of a transmitting apparatus and a decoder of a receiving apparatus, transmission of the subdivision iteration unit and subdivision iteration count to the decoder may be omitted. In the present disclosure, the encoder of the transmitting apparatus may be referred to as a dynamic mesh encoder, and the decoder of the receiving device may be referred to as a dynamic mesh decoder.

That is, according to the present disclosure, transmission of information on the subdivision iteration count and subdivision iteration unit to a mesh decoder of the receiving device may be omitted by adaptively applying whether or not to perform subdivision of the subdivision iteration unit of a dynamic mesh and the subdivision iteration count according to the feature of the mesh surface, or the like.

As such, according to the present disclosure, by adaptively setting a subdivision level, when subdivision is not performed for a specific subdivision iteration unit, there is an advantage in that the number of vertices to be reconstructed is reduced, thereby reducing the amount of displacement vector bits, which leads to improved coding performance.

In the present disclosure, geometry information (or geometry or geometry data) is one of elements that constitute a mesh, and includes vertices (or points), edges, and polygons. Here, the vertices define positions in 3D space, the edges represent connection information between vertices, and the polygons form a surface of the mesh as a combination of edges and vertices. That is, each vertex that constitutes the mesh represents a position in three-dimensional (3D) space, expressed as X, Y, Z coordinates, for example. The polygon may be a triangle or a square. In other words, geometry forms the skeleton of a 3D model, defining a shape of the model and visually representing the model when rendered.

FIG. 15 shows a transmitting apparatus according to embodiments. The transmitting apparatus of FIG. 15 may be referred to as a mesh data transmitting apparatus, an encoder, a V-Mesh encoder, or a dynamic mesh encoder.

FIG. 15 corresponds to the transmitting apparatus 100 or mesh video encoder 102 of FIG. 1, the encoder (preprocessor and encoder) of FIGS. 2, 6, or 7, the transmitting apparatus of FIG. 13 and/or a transmitting encoding apparatus corresponding thereto. Each component of FIG. 15 corresponds to hardware, software, a processor, and/or a combination thereof. In FIG. 15, the execution order of each block may be changed, some blocks may be omitted, and some blocks may be newly added.

In the present disclosure, the process of operations at the transmitting end for compression and transmission of dynamic mesh data by using V-Mesh compression technology may be as shown in FIG. 15. The transmitting apparatus of FIG. 15 may support both an intra-frame encoding (or intra-encoding or intra-screen encoding) process and/or an inter-frame encoding (or inter-encoding or inter-screen encoding) process.

In FIG. 15, a mesh decimation unit 11011 decimates an input original mesh through a mesh decimation algorithm to generate a base mesh (or decimated base mesh or decimated mesh). In this case, mesh decimation may be performed based on the number of target vertices or target polygons that constitute the mesh. For example, a method such as decimation may be used as the mesh decimation algorithm to decimate the original mesh. That is, the decimation method may be a process of selecting vertices to be removed from the original mesh by using some reference point, and then removing the selected vertices and the triangles connected to the selected vertices.

That is, the mesh decimation unit 11011 may perform decimation of the input mesh to the target number of vertices or the target number of faces. In this case, the decimation process may be performed through various methods such as triangle collapse and edge collapse.

According to embodiments, the base mesh decimated in the mesh decimation unit 11011 is provided to a mesh parameterization unit 11012 and a mesh feature extractor 11018.

The mesh parameterization unit 11012 performs a process of mapping a 3D surface to a texture domain for a decimated mesh. That is, the mesh parameterization unit 11012 generates texture coordinates and texture connection information of the input mesh. According to an embodiment, the mesh parameterization unit 11012 may perform parameterization by using a UV Atlas tool. Through this process, mapping information about a location on a 2D image, to which each vertex of the simplified mesh (decimated mesh) is to be mapped is generated. The mapping information is expressed and stored as texture coordinates, and through this process a final base mesh is generated. That is, the mesh parameterization unit 11012 performs parameterization to generate texture coordinates (UV coordinates) and texture connection information per vertex of the input mesh (i.e., decimated mesh or decimated base mesh).

The final base mesh generated in the mesh parameterization unit 11012 is input to a mesh quantizer 11013 and quantized. According to embodiments, the mesh quantizer 11013 may perform a task of quantizing floating-point type mesh information (e.g., geometry information (x, y, z) or/and texture coordinates (u, v), and normal information (nx, ny, nz)) into fixed-point type mesh information. That is, the mesh quantizer 11013 may quantize the vertex coordinates and texture coordinates of the base mesh. In some embodiments, quantization for certain components may be omitted.

According to embodiments, the mesh feature extractor 11018 extracts (or calculates) the mesh feature based on the decimated base mesh.

According to embodiments, a subdivision count determination unit 11019 determines whether to perform subdivision of a subdivision iteration unit and the subdivision iteration count based on the mesh feature, which is extracted by the mesh feature extractor 11018. In the present disclosure, the subdivision iteration count is performed is used in the same meaning as the subdivision count, and the subdivision iteration unit is used in the same meaning as a subdivision unit.

According to embodiments, a mesh subdivision unit 11020 subdivides the mesh of the corresponding subdivision iteration unit among the decimated base meshes based on the subdivision iteration count determined by the subdivision count determination unit 11019. That is, the mesh subdivision unit 11020 may perform mesh subdivision by as much as the subdivision iteration count determined by the subdivision count determination unit 11019 on the base mesh of the corresponding subdivision iteration count among the base meshes to generate additional vertices. Vertex connection information, texture coordinates, and texture coordinate connection information including added vertices according to the subdivision method may be generated. In this case, depending on the subdivision method, geometry information connection information, texture coordinate connection information, and texture coordinates may be implicitly derived and generated. According to embodiments, the mesh subdivision unit 11020 may perform subdivision through methods such as mid-edge, Loop, and Catmul&Clark.

Detailed descriptions of the mesh feature extraction of the mesh feature extractor 11018, determination of the subdivision iteration count of the subdivision count determination unit 11019, and the mesh subdivision of the mesh subdivision unit 11020 will be provided below.

According to embodiments, a mesh fitting unit 11021 may perform fitting by adjusting vertex positions such that the mesh subdivided in the mesh subdivision unit 11020 is similar to the original mesh, thereby generating a fitted subdivided mesh.

In the present disclosure, the mesh decimation unit 11011, the mesh parameterization unit 11012, the mesh feature extractor 11018, the subdivision count determination unit 11019, the mesh subdivision unit 11020, and the mesh fitting unit 11021 may be collectively referred to as a pre-processor. According to embodiments, the pre-processor may further include a displacement vector calculator 11022.

According to embodiments, the base mesh quantized in the mesh quantizer 11013 may be output to a motion vector encoder 11015 or a static mesh encoder 11016 through a switching unit 11014.

According to embodiments, the base mesh is output to the motion vector encoder 11015 through the switching unit 11014 when performing inter encoding for the corresponding mesh frame and is output to the static mesh encoder 11016 through the switching unit 11014 when performing intra encoding for the corresponding mesh frame. The motion vector encoder 11015 may be referred to as a motion encoder.

For example, when performing intra encoding or intra frame encoding for the corresponding mesh frame, the base mesh may be compressed through the static mesh encoder 11016. In this case, encoding may be performed on the connection information, vertex geometry information, vertex texture information, and normal information of the base mesh. That is, vertex coordinates, vertex connection information, texture coordinates, and texture connection information of the mesh may be encoded in the static mesh encoder 11016. The base mesh bitstream generated through encoding is transmitted to a multiplexer (not shown).

As another example, when performing inter encoding (or inter frame encoding) for the corresponding mesh frame, the motion vector encoder 11015 may receive a base mesh and a reference reconstructed base mesh (or a reconstructed quantized reference base mesh) as input, calculate a motion vector between the two meshes, and encode the value. The motion vector encoder 11015 may perform prediction based on connection information by using previously encoded/decoded motion vectors as a predictor and entropy-encode a differential motion vector (also called a residual motion vector) obtained by subtracting the predicted motion vector from the current motion vector. The motion vector bitstream generated through encoding is transmitted to a multiplexer (not shown) as a base mesh bitstream. That is, in the case of intra-screen encoding, the static mesh bitstream is input to the multiplexer as the base mesh bitstream, and in the case of inter-screen encoding, the motion vector bitstream is input to the multiplexer as the base mesh bitstream.

In FIG. 15, a base mesh decoder 11017 may receive a base mesh encoded by the static mesh encoder 11016 or the motion vector encoded by the motion vector encoder 11015 and generate a reconstructed base mesh. The base mesh decoder 11017 performs reconstruction of the base mesh according to an encoding type of the current mesh (inter-screen encoding or intra-screen encoding). For example, the base mesh decoder 11017 may perform static mesh decoding on the base mesh encoded by the static mesh encoder 11016 to reconstruct the base mesh. In this case, quantization may be applied before static mesh decoding, and inverse quantization may be applied after static mesh decoding. That is, when intra-screen encoding is performed, the current base mesh may be reconstructed by performing inverse quantization on the quantized base mesh through the mesh quantizer 11013. As another example, the base mesh decoder 11017 may reconstruct the base mesh based on the reconstructed quantized reference base mesh and the motion vector encoded in the motion vector encoder 11015. That is, when inter-screen encoding is performed, the current base mesh may be generated by decoding the motion vector by using the motion vector decoding method and then applying (i.e., adding) the decoded motion vectors to the reference reconstructed base mesh. In this case, when the motion vector is not quantized, the motion vector reconstruction process may be omitted and the current base mesh may be reconstructed by using the motion vector calculated in the motion vector encoder 11015. The reconstructed base mesh is output to the displacement vector calculator 11022 and a mesh inverse quantizer 11028.

According to embodiments, the displacement vector calculator 11022 may perform mesh subdivision on the reconstructed base mesh. In this case, according to an embodiment, the subdivision iteration count of the reconstructed base mesh is the same as the subdivision iteration count determined by the subdivision count determination unit 11019. The displacement vector calculator 11022 may calculate a displacement vector, which is a difference value in vertex positions between the subdivided reconstructed base mesh and the fitted subdivision (or subdivided) mesh generated by the mesh fitting unit 11021. In this case, the displacement vector may be calculated as many times as the number of vertices of the subdivided mesh. That is, the displacement vector of the number of vertices of the subdivided mesh may be calculated through a displacement vector calculator 11021.

According to embodiments, a displacement vector coordinate system converter 11023 may convert a vertex displacement vector calculated in a three-dimensional (3D) Cartesian coordinate system (i.e., (x, y, z) space) into a local coordinate system (i.e., normal, tangential, or bi-tangential coordinate system) based on the normal vector of each vertex. In this case, the normal vector may be calculated for each subdivided vertex based on the geometric information and connection information of the surrounding vertices.

According to embodiments, a displacement vector converter 11024 may perform conversion on a displacement vector of the (x, y, z) or (n, t, bt) coordinate system. Here, the conversion may be applied as a lifting conversion, wavelet transformation, or the like in some embodiments. In the (n, t, bt) coordinate system, n stands for normal, t stands for tangential, and bt stands for bi-tangential.

For example, when the lifting conversion is performed, when performing prediction of a vertex Rₖ of a kth subdivision level, prediction of a displacement vector of the kth subdivision level may be performed through a subdivision vertex displacement vector of Rₜ (t<k or t<=k) as a predictor. According to embodiments, when performing prediction of a displacement vector, an average or distance-based weighted average prediction may be performed on n points near the current vertex based on connection information among vertices with a lower subdivision level than the current vertex. According to embodiments, prediction may be performed based on the displacement vectors of n vertices used to generate the current vertex in the mesh subdivision operation.

When lifting conversion is performed, a process of updating the displacement vector of the vertex used for prediction may be performed through a residual signal generated by prediction.

According to embodiments, a displacement vector quantizer 11025 may perform quantization on the displacement vector value converted through the displacement vector converter 11024, i.e., the displacement vector or a displacement vector conversion coefficient.

According to embodiments, a displacement vector encoder 11026 may perform encoding on the displacement vector or displacement vector conversion coefficient output from the displacement vector quantizer 11025. In the present disclosure, the displacement vector encoder 11026 may perform encoding through a zero run length encoder, an arithmetic encoder, or the like. For example, when the encoding method is based on video encoding, the displacement vector or displacement vector conversion coefficient may be packed into a frame and encoded. That is, the displacement vector encoder 11026 may pack the displacement vector conversion coefficient into a 2D image and then encode the displacement vector conversion coefficient by using a 2D video codec (i.e., a video compression codec) or zero run-length encode the displacement vector conversion coefficient to generate a displacement vector video bitstream.

According to embodiments, the displacement vector video bitstream encoded and generated by the displacement vector encoder 11026 is transmitted to a multiplexer (not shown). According to embodiments, the selection method of the displacement vector encoder 11026 may use a displacement vector encoder promised in an encoder (i.e., a transmitting side)/decoder (i.e., a receiving side) or may analyze the feature of the displacement vector in an encoder on the transmitting side and transmit a type of the selected displacement vector encoder to a decoder on the receiving side.

According to embodiments, a displacement vector reconstructor 11027 may reconstruct the displacement vector by performing a reverse process of displacement vector encoding on the displacement vector or displacement vector conversion coefficient encoded in the displacement vector encoder 11026. That is, the displacement vector reconstructor 11027 may perform displacement vector depacking depending on the method of encoding the displacement vector, for example, when encoded based on a video codec. The displacement vector reconstructor 11027 may additionally perform inverse quantization, inverse transformation, or the like depending on whether quantization and conversion processes are performed during a displacement vector encoding process.

According to embodiments, the mesh inverse quantizer 11028 may dequantize vertex coordinates or texture coordinates of the reconstructed base mesh through a reverse process of quantization. When the quantization process is omitted in the mesh quantizer 11013, the dequantization process is also omitted in the mesh inverse quantizer 11028.

According to embodiments, a mesh reconstructor 11029 may reconstruct a mesh based on the reconstructed base mesh output from the displacement vector reconstructor 11027 and the reconstructed base mesh (or a dequantized reconstructed base mesh) output from the mesh inverse quantizer 11028. In more detail, the mesh reconstructor 11029 may perform subdivision on the reconstructed base mesh output from the mesh inverse quantizer 11028 and add the displacement vector reconstructed by the displacement vector reconstructor 11027 to generate a reconstructed deformed mesh. According to embodiments, the mesh reconstructed by the mesh reconstructor 11029 (or reconstructed mesh or reconstructed deformed mesh) has reconstructed vertices, connection information between vertices, texture coordinates, and connection information between texture coordinates. The reconstructed mesh (or reconstructed mesh or reconstructed deformed mesh) generated in the mesh reconstructor 11029 is provided to a texture map generation unit 11030.

According to embodiments, the texture map generation unit 11030 may regenerate a texture map of the current mesh based on the texture map (or attribute map) of the original mesh and the mesh reconstructed by the mesh reconstructor 11029. That is, the texture map generation unit 11030 may generate a texture map of the reconstructed mesh through the texture map and a relationship between the original mesh and the reconstructed mesh.

According to embodiments, the texture map generation unit 11030 may assign color information per vertex of the texture map of the original mesh to the texture coordinates of the reconstructed base mesh (or the reconstructed deformed mesh). According to embodiments, the texture map generation unit 11030 may generate a texture map (or texture map video) by grouping the regenerated texture maps for each frame into GoF units.

The texture map generated in the texture map generation unit 11030 may be encoded in a texture map encoder 11031. For example, the texture map encoder 11031 may encode a texture map by using a 2D video codec, a zero run length encoder, an entropy coding-based arithmetic encoder, or the like. The texture map encoder 11031 may further perform color space conversion of the texture map. Then, the texture map substream (or texture map video bitstream) generated through texture map encoding is transmitted to a multiplexer (not shown).

According to embodiments, the type of texture map encoder 11031 may include a video encoder (e.g., VVC, or HEVC), and an entropy coding-based encoder. The selection method of the texture map encoder 11031 may use a texture map encoder promised in an encoder (i.e., a transmitting side)/decoder (i.e., a receiving side) or may transmit a type of the selected texture map encoder on the transmitting side.

According to embodiments, a multiplexer (not shown) may multiplex an input base mesh bitstream, a displacement vector bitstream, and a texture map bitstream into one bitstream and then transmit the same to the receiving apparatus. Alternatively, the base mesh bitstream, the displacement vector bitstream, and the texture map bitstream may be encapsulated into a file/segment and transmitted to the receiving apparatus.

According to embodiments, the bitstream multiplexed in the multiplexer may be transmitted over a network or stored in a digital storage medium. Here, the network may include a broadcasting network and/or a communication network, and the digital storage medium may include various storage media such as USB, SD, CD, DVD, Blu-ray, HDD, and SSD.

Hereinafter, a process of determining a subdivision iteration count based on the mesh feature and performing subdivision according to the determined subdivision iteration count is described. In this case, according to the present disclosure, mesh non-uniform subdivision based on the mesh feature may be performed.

That is, according to the present disclosure, the subdivision iteration count may be determined differently for each subdivision iteration unit and the mesh may be subdivided for each subdivision iteration unit. The subdivision iteration count according to the subdivision iteration unit based on the mesh feature may be calculated by using the same manner in an encoder of a transmitting apparatus and a decoder of a receiving apparatus and mesh subdivision may be performed. Then, the process of transmitting the subdivision iteration unit and the subdivision iteration count to the decoder of the receiving apparatus may be omitted.

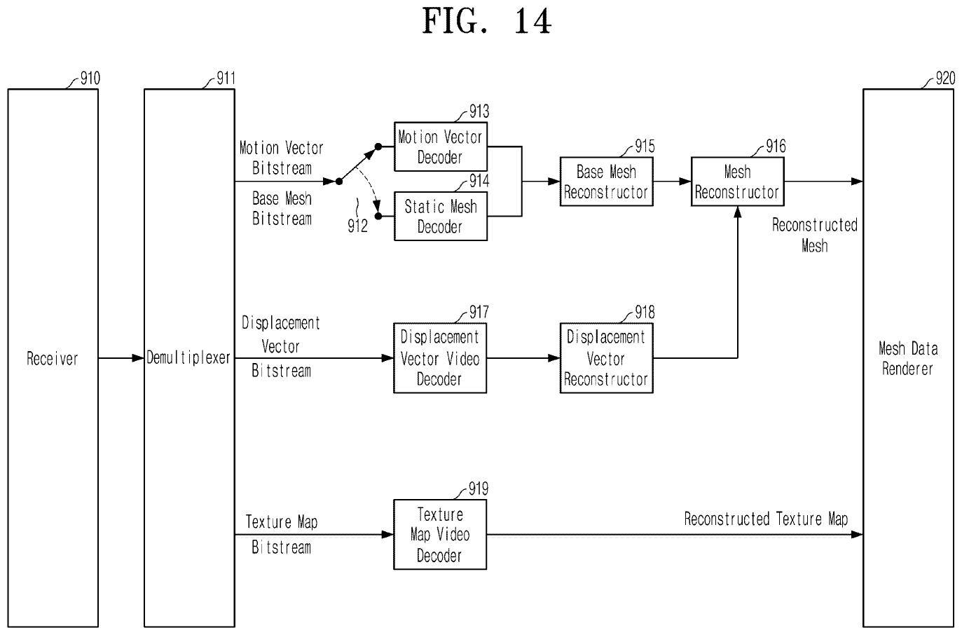

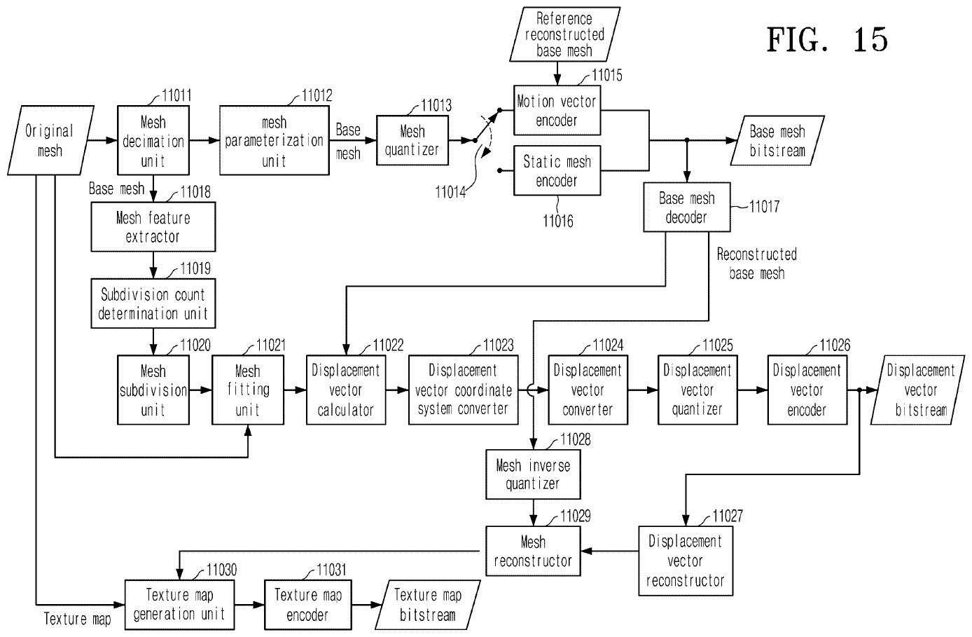

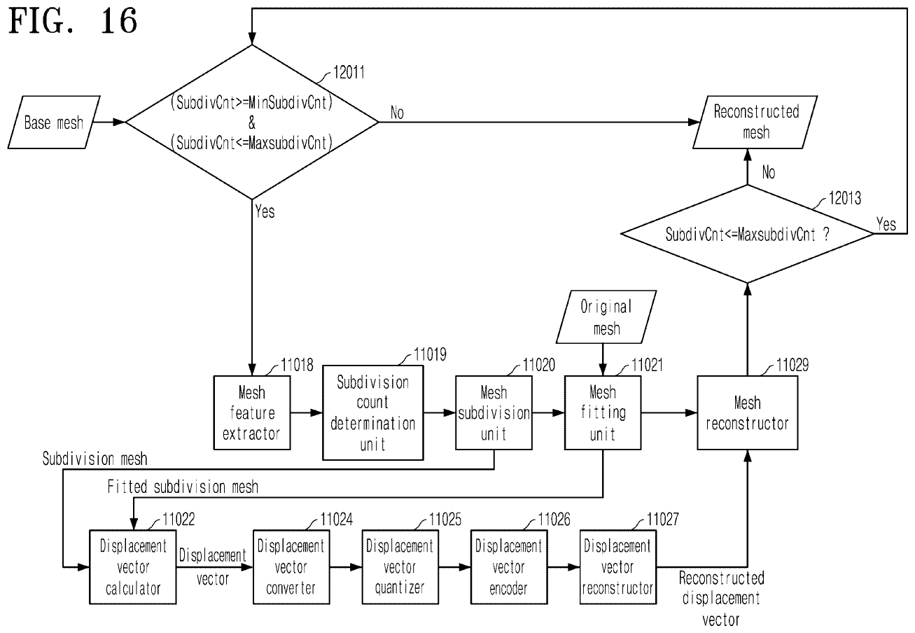

FIG. 16 is a diagram showing an example in which a dynamic mesh encoder performs a mesh subdivision process based on the mesh feature according to embodiments. That is, FIG. 16 shows an example of a process of performing mesh non-uniform subdivision based on the mesh feature in a dynamic mesh encoder according to embodiments. In adding reference numerals to components of FIG. 16, components that are the same or similar to those of FIG. 15 are given the same reference numbers, and repeated descriptions thereof may be omitted.

For convenience of explanation, in the present disclosure, reference numeral 12011 is referred to as a first determination unit, and reference numeral 12013 is referred to as a second determination unit.

SubdivCnt may be defined as the current subdivision iteration count, MinSubdivCnt as the minimum subdivision iteration count, and MaxSubdivCnt as the maximum subdivision iteration count.

In the present disclosure, MinSubdivCnt and MaxSubdivCnt may be determined by a user in an encoder or may be determined according to a mesh feature, a target bitrate, or the like.

According to the present disclosure, whether to perform subdivision may be determined using MinSubdivCnt and MaxSubdivCnt.

In this case, MinSubdivCnt and MaxSubdivCnt may use the same value by agreement between the encoder of the transmitting apparatus and the decoder of the receiving apparatus, or may be transmitted from the encoder of the transmitting apparatus to the decoder of the receiving apparatus, and may be transmitted in units of patches or mesh sequences.

According to an embodiment of the present disclosure, a process of calculating the subdivision iteration count when SubdivCnt, which means the current subdivision iteration count, is greater than or equal to MinSubdivCnt and less than or equal to MaxSubdivCnt may be performed. In other words, according to an embodiment, the subdivision iteration count may be calculated based on the mesh feature and subdivision may be performed only when SubdivCnt is between MinSubdivCnt and MaxSubdivCnt. When the above condition is not satisfied, that is, when SubdivCnt is less than MinSubdivCnt or larger than MaxSubdivCnt, the process of calculating the mesh feature and performing subdivision may not be performed. That is, subdivision may not be performed on a specific subdivision iteration unit by adaptively setting a subdivision level, and in a subdivision iteration unit in which subdivision is not performed, displacement vector calculation and mesh reconstruction processes are not required, and thus, the number of vertices to be reconstructed is reduced, which has an advantage of reducing the amount of displacement vector bits.

To this end, a first determination unit 12011 of FIG. 16 checks whether SubdivCnt is greater than or equal to MinSubdivCnt and less than or equal to MaxSubdivCnt. According to embodiments, the mesh feature extractor 11018 operates and extracts the mesh feature only when the first determination unit 12011 determines that SubdivCnt is greater than or equal to MinSubdivCnt and less than or equal to MaxSubdivCnt.

As such, the mesh feature extractor 11018 calculates the mesh feature when the conditions (SubdivCnt>=MinSubdivCnt) & (SubdivCnt<=MaxSubdivCnt) are satisfied, and the subdivision count determination unit 11019 determines the subdivision iteration count for each subdivision iteration unit based on the calculated mesh feature. The mesh subdivision unit 11020 may perform subdivision for each subdivision iteration unit based on the subdivision iteration count determined for each subdivision iteration unit.

According to the present disclosure, determination of the subdivision iteration count based on the mesh feature and subdivision may not be performed when the conditions (MinSubdivCnt<=SubdivCnt) & (SubdivCnt<=MaxSubdivCnt) are not satisfied. In this case, the displacement vector calculation and mesh reconstruction processes may be omitted.

FIG. 17(a) and 17(b) are diagrams showing examples of original meshes and base meshes expressed in 1D according to embodiments. That is, FIG. 17(a) shows an example of expressing a portion of a 3D original mesh in one dimension according to embodiments, and FIG. 17(b) shows an example of expressing a decimated base mesh based on the original mesh of FIG. 17(a) in one dimension.

As shown in FIG. 17(a), the distribution of vertices in the original mesh is not uniform. When the original mesh is decimated to generate a base mesh, the distribution of vertices in the base mesh is not uniform, as shown in FIG. 17(b). That is, depending on objects that constitute the mesh, some areas of the mesh may have densely packed vertices, while other areas may have scattered vertices.

According to the present disclosure, mesh subdivision may be performed in more detail only on a specific area of the mesh based on the mesh feature. That is, when the subdivision iteration count is determined to be the same value for each frame or patch without considering these features, the subdivision process may be performed even for areas in which subdivision is unnecessary, and the displacement vector of the vertex generated thereby needs also to be transmitted. The present disclosure is provided to prevent this.

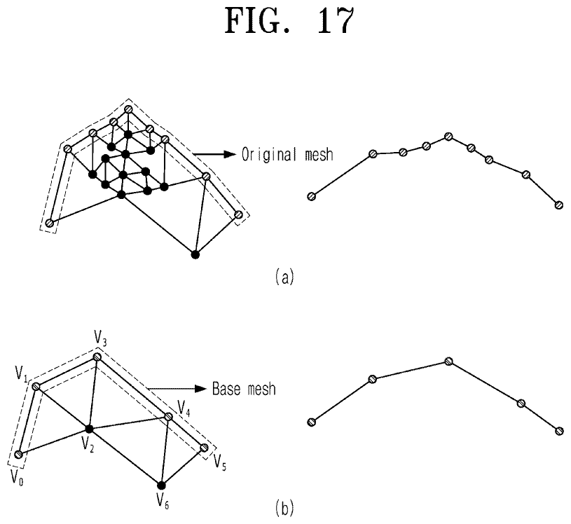

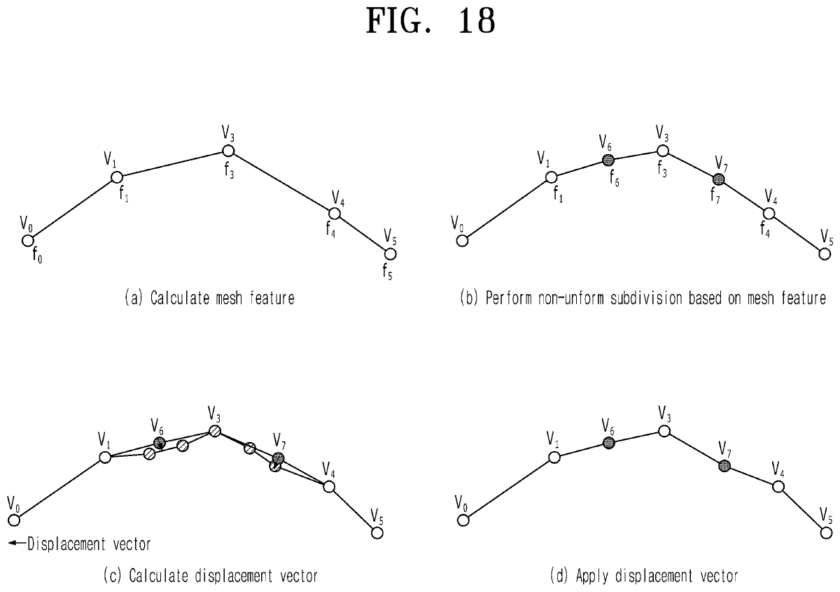

FIG. 18(a) to 18(d) are diagrams showing an example of performing a non-uniform mesh subdivision process based on the vertex feature according to embodiments. That is, FIG. 18(a) to 18(d) show examples of a process of calculating the mesh feature in a dynamic mesh encoder and performing non-uniform subdivision of the mesh based on the calculated mesh feature.

In other words, FIG. 18(a) to 18(d) show a process of calculating the feature of the base mesh, performing subdivision on an area in which the feature is greater than a specific threshold, calculating a displacement vector between the subdivided mesh and the fitted mesh, and applying the displacement vector to the subdivided mesh. This process may be performed by the operations of all or some of the mesh feature extractor 11018, the subdivision count determination unit 11019, the mesh subdivision unit 11020, the mesh fitting unit 11021, the displacement vector calculator 11022, the displacement vector coordinate system converter 11023, the displacement vector converter 11024, the displacement vector quantizer 11025, the displacement vector encoder 11026, the displacement vector reconstructor 11027, and the mesh reconstructor 11029.

In more detail, FIG. 18(a) shows an example of extracting the feature of a base mesh according to embodiments. In FIG. 18(a), according to an embodiment, Vᵢ is a vertex at an i-th index, and fᵢ is a feature value of the vertex at the i-th index.

That is, the mesh feature extractor 11018 may calculate the feature value of the mesh for each vertex, and the subdivision count determination unit 11019 may increase the subdivision iteration count of the corresponding area (i.e., the corresponding subdivision iteration unit) when the feature value of the mesh calculated for each vertex is greater than a specific threshold.

FIG. 18(b) shows an example of performing non-uniform subdivision based on the feature values of the mesh calculated as in FIG. 18(a). That is, as shown in FIG. 18(b), the subdivision count determination unit 11019 may determine the subdivision iteration count of a specific area (i.e., a subdivision iteration unit) based on the mesh feature, and the mesh subdivision unit 11020 performs subdivision on the corresponding area (i.e., the corresponding subdivision iteration unit).

According to an embodiment of the present disclosure, the subdivision count determination unit 11019 and the mesh subdivision unit 11020 perform subdivision by increasing the subdivision iteration count (e.g., SubdivCnt) by 1 for each vertex, edge, or triangle mesh unit (or face unit) of which mesh feature is greater than a threshold. In the present disclosure, a vertex, edge, or triangle mesh (or face) may be referred to as a subdivision iteration unit (or area or subdivision iteration area). That is, according to the present disclosure, whether to perform subdivision and the subdivision iteration count based on the feature of the corresponding area in a face unit or smaller units.

FIG. 18(c) shows an example of calculating a displacement vector in the displacement vector calculator 11022 according to embodiments. That is, the displacement vector calculator 11022 calculates a displacement vector between the mesh subdivided by performing the non-uniform subdivision in the mesh subdivision unit 11020 and the mesh fitted in the mesh fitting unit 11021.

FIG. 18(d) shows an example of obtaining a reconstructed mesh (or reconstructed mesh) by applying a displacement vector to a mesh subdivided by a non-uniform subdivision process according to embodiments. That is, the displacement vector calculated in the displacement vector calculator 11022 is encoded and reconstructed through at least one of the displacement vector coordinate system converter 11023, the displacement vector converter 11024, the displacement vector quantizer 11025, the displacement vector encoder 11026, or the displacement vector reconstructor 11027, and the reconstructed displacement vector is provided to the mesh reconstructor 11029. The mesh reconstructor 11029 reconstructs the mesh by using the mesh fitted by the mesh fitting unit 11021 and the displacement vector reconstructed by the displacement vector reconstructor 11027.

According to embodiments, when the mesh is reconstructed in the mesh reconstructor 11029, a second determination unit 12013 checks whether the current subdivision iteration count (SubdivCnt) is less than or equal to MaxSubdivCnt. When the current subdivision iteration count (SubdivCnt) is less than or equal to MaxSubdivCnt, the process proceeds to the first determination unit 12011 and the mesh feature extraction described above and subdivision count determination process is repeated, and when it is greater than MaxSubdivCnt, the reconstructed mesh is provided to the texture map generation unit 11030. That is, after reconstructing the mesh in the mesh reconstructor 11029, when SubdivCnt is less than MaxSuddivCnt, the process proceeds to operation 12011 to determine whether to perform subdivision again, and the processes described above are repeated. As such, according to the present disclosure, non-uniform subdivision is repeatedly performed when SubdivCnt is between MinSubdivCnt and MaxSubdivCnt.

Hereinafter, the mesh feature extractor 11018, the subdivision count determination unit 11019, the mesh subdivision unit 11020, and the displacement vector calculator 11022 will be described in detail.

### Mesh Feature Extractor 11018

According to embodiments, the mesh feature extractor 11018 calculates the mesh feature.

In this case, a unit for extracting the mesh feature may be a vertex unit (i.e., each vertex of the mesh), a face unit, a fan unit, or the like. That is, the mesh feature extractor 11018 may calculate the mesh feature in units of mesh vertices, in units of fans, or in units of faces.

According to embodiments, the types of mesh feature extracted by the mesh feature extractor 11018 may be curvature, convexity, concavity, planarity, dihedral angle, a degree of change in normal vector, motion vector feature, texture map feature, geodesic distances, or the like. An embodiment of the present disclosure is described in terms of curvature.

When the mesh feature is considered as curvature, the mesh feature extractor 11018 may calculate the mesh curvature through various algorithms. According to embodiments, the algorithm for calculating curvature may include Gaussian curvature, mean curvature, and principal curvature.

The same type of mesh feature may be calculated by an agreement between the encoder of the transmitting apparatus and the decoder of the receiving apparatus, or information indicating the type of mesh feature used in the encoder (e.g., FeatureType) may be transmitted to the decoder of the receiving apparatus.

### Subdivision Count Determination Unit 11019

According to embodiments, the subdivision count determination unit 11019 may determine the subdivision iteration count based on the mesh feature, which is calculated by the mesh feature extractor 11018.

In this case, a unit for determining the subdivision iteration count may be a face unit or a fan unit. That is, the subdivision count determination unit 11019 may determine whether to perform subdivision and the subdivision iteration count in units of faces based on the mesh feature extracted in units of vertices, faces, or fans, or may determine whether to perform subdivision and the subdivision iteration count in units of fans. According to an embodiment of the present disclosure, determination of whether to perform subdivision and a subdivision iteration count in units of faces (e.g., triangle mesh unit) is described.

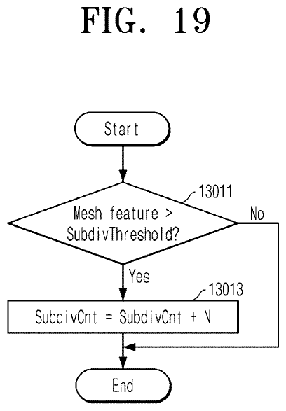

FIG. 19 is a diagram showing an example of a method of determining a subdivision iteration count according to embodiments. In FIG. 19, SubdivThreshold is a threshold used as a determination reference to determine the subdivision iteration count based on mesh feature (i.e., according to mesh feature). In the present disclosure, SubdivThreshold may be determined by a user in the encoder of the transmitting apparatus or may be determined based on mesh features, a target bitrate, or the like. SubdivThreshold may use the same value by agreement between the encoder of the transmitting apparatus and the decoder of the receiving apparatus, or may be transmitted to the decoder of the receiving apparatus. When SubdivThreshold is transmitted to the decoder of the receiving apparatus, SubdivThreshold may be transmitted on a patch basis, mesh sequence basis, or the like.

Referring to FIG. 19, in operation 13011, whether the mesh feature are greater than SubdivThreshold is checked. When it is determined in operation 13011 that the mesh feature is greater than SubdivThreshold, the subdivision iteration count may be determined by adding N to SubdivCnt, which indicates the current subdivision iteration count (13013). Here, N may be a fixed value (e.g., 1). In this case, SubdivCnt is an example in which a count value increases from 0 to N. That is, when determining subdivision for the base mesh, a value of SubdivCnt is 0. For example, when N is 1, SubdivCnt increases by 1, and when N is 2, SubdivCnt increases by 2. Alternatively, in operation 13013, an absolute value of a difference between the mesh feature and the threshold may be determined, and then the subdivision iteration count may also be determined in consideration of a ratio of the absolute value.

When the subdivision iteration count is determined in units of faces, the subdivision count determination unit 11019 may determine the subdivision iteration count for the corresponding face if feature values of some of the vertices constituting the face are greater than or equal to a threshold, or may determine the subdivision iteration count for the corresponding face if an average of the feature values of the vertices constituting the face is greater than or equal to the threshold.

### Mesh Subdivision Unit 11020

According to embodiments, the mesh subdivision unit 11020 may perform subdivision on the base mesh to generate additional vertices. That is, the mesh subdivision unit 11020 may generate a sub-mesh by performing a subdivision process that generates a new vertex in the middle of edges between vertices.

According to embodiments, the mesh subdivision unit 11020 may perform subdivision for each subdivision iteration unit according to the subdivision iteration count calculated (or determined) in the subdivision count determination unit 11019.

In this case, subdivision may be performed in the same subdivision iteration unit in the encoder of the transmitting apparatus and the decoder of the receiving apparatus depending on the subdivision iteration count. In this case, transmission of the subdivision iteration unit and the subdivision iteration count to the decoder may be omitted. That is, when calculating the subdivision iteration count according to the subdivision iteration unit based on the mesh feature by using the same manner in an encoder of a transmitting apparatus and a decoder of a receiving apparatus, transmission of the subdivision unit and subdivision iteration count to the decoder may be omitted. Here, the subdivision iteration count may be determined differently for each subdivision iteration unit.

According to embodiments, the subdivision iteration unit may be a face unit, a fan unit, or the like. The subdivision iteration unit may be a unit that uses a mesh subdivision algorithm to cluster faces having similar feature values by using feature values calculated in the mesh feature extractor 11018.

In the present disclosure, the subdivision iteration unit may be determined to be the same subdivision iteration unit by agreement between the encoder of the transmitting apparatus and the decoder of the receiving apparatus, or information for identifying the subdivision iteration unit determined by the encoder may be transmitted to the decoder.

According to embodiments, when the current mesh is a base mesh, the mesh subdivision unit 11020 may increase the subdivision iteration count calculated by the subdivision count determination unit 11019 by N, and then subdivide some areas of the base mesh N times. When the current mesh is a reconstructed mesh by applying a displacement vector after performing subdivision, the mesh subdivision unit 11020 may increase the subdivision iteration count by N and then subdivide some areas of the reconstructed mesh N times.

According to embodiments, the mesh subdivision method performed by the mesh subdivision unit 11020 may include Midpoint subdivision, Loop subdivision, Butterfly subdivision, and Catmull-Clark subdivision.

According to embodiments, the mesh subdivision method may perform subdivision by using the same mesh subdivision method by agreement between the encoder of the transmitting apparatus and the decoder of the receiving apparatus, or may transmit information (e.g., SubdivMethod) for identifying the mesh subdivision method determined by the encoder to the decoder of the receiving apparatus.

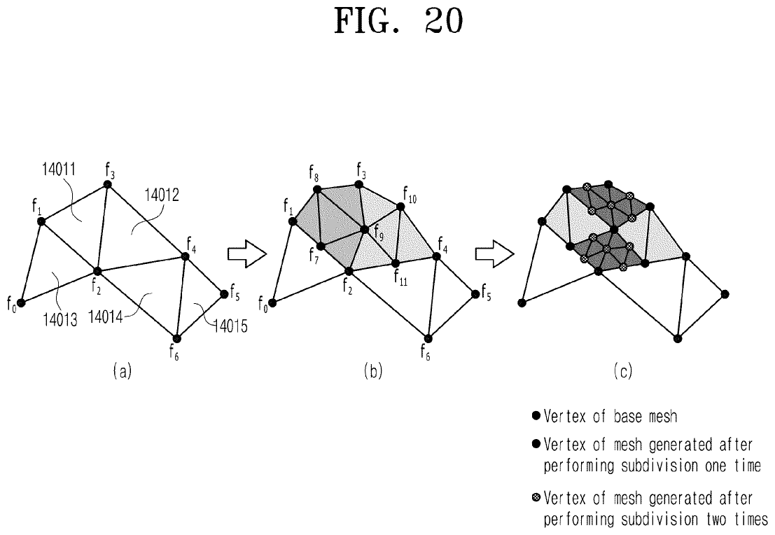

FIG. 20(a) to 20(c) are diagrams showing an example of a mesh subdivision process according to embodiments. That is, FIG. 20(a) to 20(c) show examples of performing mesh non-uniform subdivision iterations in units of triangle meshes (or faces) based on mesh feature values.

In more detail, FIG. 20(a) to 20(c) show examples of repeatedly performing subdivision while increasing SubdivCnt, which is the subdivision iteration count, from 0 to 1 for an area (e.g., a triangle mesh or face) in which a mesh feature value is greater than a specific threshold until SubdivCnt is 2 assuming that MinSubdivCnt is 0 and MaxSubdivCnt is 2.

In this case, according to an embodiment, a unit for calculating the mesh feature value is a vertex unit, and a unit for performing subdivision is a face (i.e., a triangle mesh). For example, a feature value may be calculated for each vertex of the base mesh, and when an average feature value of the vertices within the face is greater than a threshold, subdivision of the corresponding face may be performed. As another example, the feature value may be calculated for each vertex of the base mesh, and subdivision may be performed on faces that have at least one vertex with a feature value greater than a threshold. This subdivision process is repeatedly performed as many times as the subdivision iteration count. This is merely one example, and a unit for calculating a mesh feature value may be any one of a vertex, a face, and a fan, and a unit for performing subdivision may be any one of a face and a fan.

In FIG. 20(a) and 20(b), fᵢ represents a mesh feature value of a vertex of an i-th index.

According to an embodiment, the feature value of each vertex of the base mesh is calculated, and an average feature value is calculated per face by applying the calculated feature value of each vertex. Subdivision may only be performed on faces of which average feature value is greater than the threshold.

According to another embodiment of the present disclosure, a feature value of each vertex of a base mesh may be calculated, and subdivision may be performed on a face to which a vertex with a feature value greater than a threshold value belongs.

FIG. 20(a) shows five faces 14011 to 14015, and subdivision is performed only for two of these faces 14011 and 14012 as in FIG. 20(b).

This may be a case in which an average feature value (f₁+f₂+f₃)/3 of the face 14011 and an average feature value (f₂+f₃+f₄)/3 of the face 14012 are greater than a threshold, or a case in which at least one of feature values f₁, f₂, and f₃ constituting the face 14011 is greater than the threshold and at least one of feature values f₂, f₃, and f₄ constituting the face 14012 is greater than the threshold. As shown in FIG. 20(a) and FIG. 20(b), no subdivision is performed on the remaining faces 14013 to 14015 except for the two faces 14011 and 14012 among the five faces 14011 to 14015, and thus a process of calculating and encoding a displacement vector for the remaining faces 14013 to 14015, reconstructing the encoded displacement vector, and reconstructing the mesh based on the reconstructed displacement vector may be omitted. That is, subdivision of the remaining faces 14013 to 14015 is not performed, and thus no displacement vector is generated. Therefore, the displacement vectors for the remaining faces 14013 to 14015 are not transmitted to the receiving apparatus, and thus the amount of displacement vector bits to be transmitted may be reduced.

In this case, when there are remaining subdivision iteration count, the feature values of each vertex of the mesh on which subdivision has been performed are recalculated, and additional subdivision is performed only for faces that satisfy the conditions based on the feature values of each recalculated vertex. This subdivision process is repeatedly performed as many times as the subdivision iteration count.

As such, according to the present disclosure, subdivision is performed only on the face(s) that satisfy the conditions among the faces (i.e., triangular meshes) that constitute the base mesh, as in FIG. 20(b). In this case, MinSubdivCnt is assumed to be 0 and MaxSubdivCnt is assumed to be 2, and thus the subdivision iteration count remains, and therefore, as in FIG. 20(c), additional subdivision is performed only for the face(s) that satisfy the condition among the faces (i.e., triangular meshes) that constitute the subdivided mesh.

According to the present disclosure, as shown in FIG. 20(b), a displacement vector is applied to a mesh on which subdivision has been performed, and a feature value for each vertex of the mesh to which the displacement vector has been applied is calculated. Additional subdivision is performed only for the face(s) that satisfy the conditions among the faces that constitute the mesh to which the displacement vector is applied, as in FIG. 20(c). For example, based on the mesh feature values of each vertex to which the displacement vector is applied, additional subdivision is performed only for faces in which the average feature value of the vertices within the face is greater than a threshold, or for faces in which at least one vertex among the mesh feature values of each vertex is greater than a threshold. In this case, for faces generated by subdivision of the base mesh for which additional subdivision is not performed, the process of calculating and encoding a displacement vector, reconstructing the encoded displacement vector, and reconstructing the mesh based on the reconstructed displacement vector may be omitted.

As such, according to the present disclosure, rather than performing subdivision on all faces that constitute the mesh, subdivision is performed only on faces that satisfy conditions based on the feature values of the mesh. Here, the mesh may be a base mesh, a mesh on which subdivision has been performed one or more times, or a mesh on which a displacement vector has been applied after subdivision.

FIG. 21(a) to 21(c) are diagrams showing another example of a mesh subdivision process according to embodiments. That is, FIG. 21(a) to 21(c) show examples of performing mesh non-uniform subdivision iterations in units of triangle meshes (or faces) based on mesh feature values.

According to an embodiment, in FIG. 21(a) to 21(c), a unit for performing subdivision is a face unit, and a subdivision iteration target is a face that includes at least one vertex of which mesh feature value is greater than a threshold. For example, the process of subdividing the face that includes two or more vertices with mesh feature values greater than a threshold may be repeated.

FIG. 21(a) shows a face of a portion of a base mesh according to embodiments. According to the present disclosure, it is assumed that feature values of vertices v₀ and v₁ in the base mesh of FIG. 21(a) are greater than a threshold. In this case, according to the present disclosure, subdivision is performed on Δv₀v₁v₂, which is a face to which the vertices v₀ and v₁ belong, i.e., a face that includes the vertices v₀ and v₁.

FIG. 21(b) shows an example of finding endpoints of edges that constitute a face and performing subdivision on the corresponding edges according to an embodiment. That is, FIG. 21(b) shows an example of finding the endpoints of the edges in Δv₀v₁v₂ that constitute the corresponding face and performing subdivision on the corresponding edge under the above condition. For example, subdivision may be performed on edges v̅₀̅v̅₁̅v̅₀̅v̅₁̅ to generate a vertex v₃, subdivision may be performed on edges v̅₀̅v̅₂̅v̅₀̅v̅₂̅ to generate a vertex v₄, and subdivision may be performed on edges v̅₀̅v̅₂̅v̅₀̅v̅₂̅ to generate a vertex v₅.

According to the present disclosure, as shown in FIG. 21(b), a mesh feature value may be calculated again on a vertex basis for a mesh on which subdivision has been performed, and additional subdivision may be performed on a face that includes two or more vertices with mesh feature values greater than a threshold.

For example, when the feature value of the vertex v₃ generated through subdivision is greater than a threshold, subdivision may be performed on a face that includes an edge connected to a vertex having a feature value greater than the threshold by comparing the feature values of the vertices (e.g., v₀, v₁, v₄, and v₅) of the edges connected to vertex v₃ with the threshold.

In FIG. 21(b), it is assumed that the feature values of vertices v₀ and v₁ are greater than a threshold. That is, the feature value of the vertex v₀, the feature value of the vertex v₁, and the feature value of the vertex v₃ are greater than the threshold, and for example, feature values of endpoints of the edges v̅₀̅v̅₂̅v̅₀̅v̅₂̅ and v̅₁̅v̅₂̅v̅₁̅v̅₂̅ are greater than the threshold.

In this case, subdivision is performed on Δv₀v₃v₄ which is a face including an edge v̅₀̅v̅₂̅v̅₀̅v̅₂̅ and Δv₁v₃v₅ which is a face including an edge v̅₁̅v̅₂̅v̅₁̅v̅₂̅. For Δv₀v₃v₄ which is a face including an edge v̅₀̅v̅₂̅v̅₀̅v̅₂̅ as an example, subdivision may be performed on an edge v̅₀̅v̅₂̅v̅₀̅v̅₂̅ to generate a vertex v₆, subdivision may be performed on an edge v̅₀̅v̅₄̅v̅₀̅v̅₄̅ o generate a vertex v₇, and subdivision may be performed on an edge v̅₃̅v̅₄̅v̅₃̅v̅₄̅ to generate a vertex v₈. For Δv₁v₃v₅ which is a face including an edge v̅₁̅v̅₂̅v̅₁̅v̅₂̅ as an example, subdivision may be performed on an edge v̅₁̅v̅₂̅v̅₁̅v̅₂̅ to generate a vertex v₉, subdivision may be performed on an edge v̅₃̅v̅₅̅v̅₃̅v̅₅̅ to generate a vertex v₁₀, and subdivision may be performed on an edge v̅₁̅v̅₂̅v̅₁̅v̅₂̅ to generate a vertex v₁₁. That is, FIG. 21(c) shows the result of calculating a feature value for each vertex of a mesh to which a displacement vector has been applied after performing non-uniform subdivision once, and then subdividing the corresponding face(s) that include one or more vertices of which calculated feature value is greater than a specific threshold.

### Displacement Vector Calculator 11022

According to embodiments, the displacement vector calculator 11022 calculates displacement vectors of vertices between a mesh generated by subdividing a base mesh by using a subdivision process and a subdivision mesh fitted to be similar to an original mesh through the mesh fitting unit 11021.

In the present disclosure, the displacement vectors may be sorted and stored in the order in which vertices are generated from the base mesh.

When the order of the vertices generated by performing subdivision is as shown in FIG. 21(c), that is, when the vertices are generated in the order of {v₀, v₁, v₂, v₃, v₄, v₅, v₆, v₇, v₈, v₉, v₁₀, v₁₁}, the displacement vector may also be mapped in the order of vertex indexes and sorted and stored in the form {d₀, d₁, d₂, d₃, d₄, d₅, d₆, d₇, d₈, d₉, d₁₀, d₁₁}. Here, vᵢ means the vertex coordinates of an i-th index, and dᵢ means a displacement vector of the i-th index.

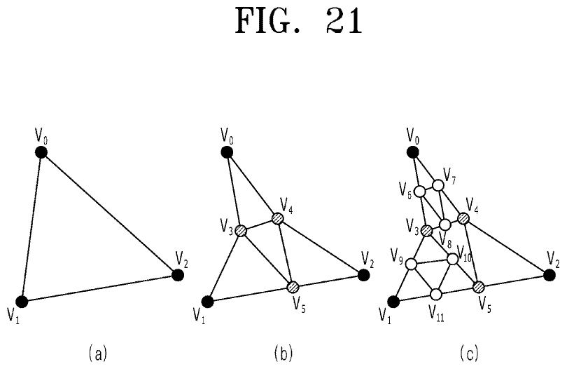

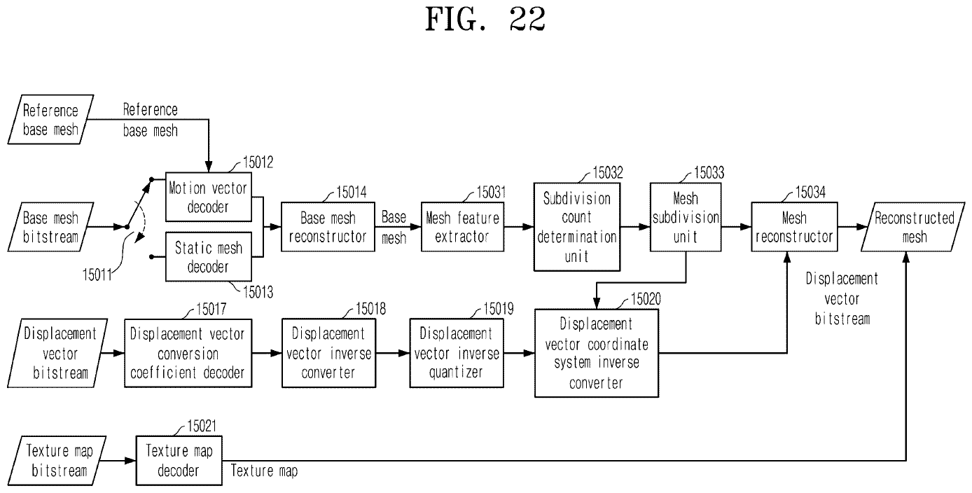

FIG. 22 shows a receiving apparatus according to embodiments. In the present disclosure, the receiving apparatus of FIG. 22 may be referred to as a mesh data receiving apparatus, a decoder, a V-Mesh decoder, or a dynamic mesh decoder.

FIG. 22 corresponds to the receiving apparatus 110 or mesh video decoder 113 of FIG. 1, the decoder of FIG. 11 or 12, the receiving apparatus of FIG. 14 and/or the receiving apparatus corresponding thereto. Each component of FIG. 22 corresponds to hardware, software, a processor, and/or a combination thereof. The receiving (decoding) operation of FIG. 22 may comply with a reverse process of the corresponding process of the transmitting (encoding) operation of FIG. 15. In FIG. 22, the execution order of each block may be changed, some blocks may be omitted, and some blocks may be newly added.

According to embodiments, a bitstream of mesh data received by a receiver (not shown) may be file/segment decapsulated and then demultiplexed into a base mesh bitstream, a displacement vector bitstream, and a texture map bitstream in a demultiplexer (not shown). When inter-screen encoding (inter encoding) is applied to the current mesh, the base mesh bitstream may be a motion vector bitstream.

According to embodiments, the base mesh bitstream is output to a motion vector decoder 1012 or a static mesh decoder 15013 through a switching unit 15011.

For example, when inter-screen encoding (i.e., inter encoding) is applied to the current mesh, the base mesh bitstream, i.e., the motion vector bitstream, is received, demultiplexed, and then output to the motion vector decoder 15012 through the switching unit 15011. As another example, when intra-screen encoding (i.e., intra encoding) is applied to the current mesh, the base mesh bitstream is received, demultiplexed, and then output to the static mesh decoder 15013 through the switching unit 15011. Here, the motion vector decoder 15012 may be referred to as a motion decoder.

According to embodiments, the motion vector decoder 15012 may perform decoding on a motion vector bitstream.

According to embodiments, the motion vector decoder 15012 may reconstruct a final motion vector by adding a differential motion vector (i.e., a residual motion vector) decoded from the motion vector bitstream by using a previously decoded motion vector as a predictor. That is, the motion vector decoder 15012 may decode a differential motion vector from the motion vector bitstream when the current base mesh is encoded in an inter-screen mode, and then reconstruct the motion vector by adding the decoded differential motion vector and the derived predicted motion vector.

According to embodiments, the static mesh decoder 15013 may decode the base mesh bitstream to reconstruct connection information, vertex geometry information, texture coordinates (i.e., attribute geometry information), normal information, or the like of the base mesh. That is, the static mesh decoder 15013 decodes the vertex coordinates, vertex connection information, texture coordinates, texture connection information, and the like of the current base mesh decoded in the in-screen mode.

According to embodiments, a base mesh reconstructor 15014 may reconstruct the base mesh according to a mode in which the base mesh is reconstructed. That is, the base mesh reconstructor 15014 may reconstruct the current base mesh based on the decoded motion vector or the decoded base mesh. For example, if the current mesh is encoded in an inter-screen mode, the base mesh reconstructor 15014 may add the motion vector decoded (or reconstructed) by the motion vector decoder 15012 to a reference base mesh and then perform inverse quantization to generate a reconstructed base mesh (i.e., the current base mesh). As another example, when the current mesh is encoded in an in-screen mode, the base mesh reconstructor 15014 may perform inverse quantization on the decoded (or reconstructed) base mesh through a static mesh decoder 15012 to generate a reconstructed base mesh (i.e., the current base mesh).

According to embodiments, a mesh feature extractor 15031 extracts the mesh feature based on the base mesh and/or signaling information reconstructed by the base mesh reconstructor 15014.

According to embodiments, a subdivision count determination unit 15032 determines the subdivision iteration count based on the mesh feature and/or signaling information extracted by the mesh feature extractor 15031.

According to embodiments, a mesh subdivision unit 15033 performs non-uniform subdivision on the base mesh based on the subdivision iteration count and/or signaling information determined by a subdivision count determination unit 15032. According to an embodiment, the mesh subdivision unit 15033 may perform mesh subdivision for the subdivision iteration count determined by the subdivision count determination unit 15032 for each subdivision iteration unit on the base mesh to generate additional vertices. Vertex connection information, texture coordinates, and texture coordinate connection information including added vertices according to the subdivision method may be generated. In this case, depending on the subdivision method, geometry information connection information, texture coordinate connection information, and texture coordinates may be implicitly derived and generated. According to embodiments, the mesh subdivision unit 15033 may perform subdivision through methods such as mid-edge, Loop, and Catmul&Clark.

Detailed descriptions of the mesh feature extraction of the mesh feature extractor 15031, determination of the subdivision iteration count of the subdivision count determination unit 15032, and non-uniform mesh subdivision of the mesh subdivision unit 15033 will be provided below.

According to embodiments, a displacement vector conversion coefficient decoder 15017 may decode and reconstruct a displacement vector by using a reverse process of a displacement vector encoding method of a transmitting side. That is, the displacement vector conversion coefficient decoder 15017 receives a displacement vector bitstream and decodes the displacement vector conversion coefficient. According to embodiments, a method of decoding a displacement vector conversion coefficient may include a video-based decoding method, a zero run length decoding method, and an arithmetic decoding method. When the encoding method in the transmitting apparatus is based on video encoding, the displacement vector conversion coefficient decoder 15017 may decode the displacement vector bitstream based on a video decoder and then perform a process of depacking a displacement vector conversion coefficient frame.

According to embodiments, the conversion coefficients decoded by the displacement vector conversion coefficient decoder 15017 are provided to a displacement vector inverse converter 15018.

According to embodiments, the displacement vector inverse converter 15018 performs inverse conversion by using the same conversion method as the displacement vector conversion process performed in the encoder of the transmitting apparatus. According to embodiments, lifting inverse conversion, wavelet inverse conversion, and the like may be performed in the displacement vector inverse converter 15018.

According to embodiments, a displacement vector inverse quantizer 15019 may inverse quantize the displacement vector inversely converted by the displacement vector inverse converter 15018, i.e., the displacement vector conversion coefficients.

According to an embodiment, conversion coefficients in the encoder of the transmitting apparatus may be quantized through different quantization parameters for each axis, and a quantization rate may be determined for each LoD level by deriving the quantization parameter or scaling parameter by an encoder/decoder agreement. That is, the inverse quantization rate may be determined differently depending on the LoD level of the mesh, or the like.

According to embodiments, a displacement vector coordinate system inverse converter 15020 may perform a process of inversely converting the reconstructed displacement vector into a Cartesian coordinate system (x, y, z) when the reconstructed displacement vector is a value of the normal coordinate system (n, t, bt).

That is, in the encoder of the transmitting apparatus, the vertex displacement vector calculated in the (x, y, z) space may be converted to a (normal, tangential, and bi-tangential) coordinate system (or normal coordinate system) based on the normal vector of each vertex. In this case, the normal vector may be calculated for each subdivided vertex based on the geometric information and connection information of the surrounding vertices.

According to embodiments of the present disclosure, a vector inverse converter 15018, the displacement vector inverse quantizer 15019, and the displacement vector coordinate system inverse converter 15020 may be collectively referred to as a displacement vector reconstructor. That is, when the displacement vector conversion coefficients decoded by the displacement vector conversion coefficient decoder 15017 pass through the displacement vector reconstructor, a final reconstructed displacement vector may be generated.

According to embodiments, the received and demultiplexed texture map bitstream is input to a texture map decoder 15021. According to embodiments, the texture map decoder 15021 decodes a texture map from a texture map bitstream. In this case, the texture map decoder 15021 may decode the texture map based on a video decoding method, a zero run length decoding method, an arithmetic decoding method, or the like. According to embodiments, the texture map decoder 15021 may perform color space conversion of the texture map.

According to embodiments, a mesh reconstructor 15034 generates a reconstructed deformed mesh, i.e., a final reconstructed mesh by applying the displacement vector reconstructed by the displacement vector reconstructor to the mesh on which non-uniform subdivision is performed in the mesh subdivision unit 15033.

According to embodiments, the mesh reconstructed by the mesh reconstructor 15034 and the texture map reconstructed by the texture map decoder 15021 are shown to a user through a rendering process in a mesh data renderer (not shown).

Hereinafter, a process of determining a subdivision iteration count based on the mesh feature and performing subdivision according to the determined subdivision iteration count is described. In this case, according to the present disclosure, mesh non-uniform subdivision based on the mesh feature may be performed.

That is, according to the present disclosure, the decoder of the receiving apparatus may also determine the subdivision iteration count differently for each subdivision iteration unit and subdivide the mesh for each subdivision iteration unit. That is, the subdivision iteration count according to the subdivision iteration unit based on the mesh feature may be calculated by using the same manner in an encoder of a transmitting apparatus and a decoder of a receiving apparatus and subdivision may be performed. Then, the encoder of the transmitting apparatus may omit the process of transmitting the subdivision iteration unit and the subdivision iteration count to the decoder of the receiving apparatus.

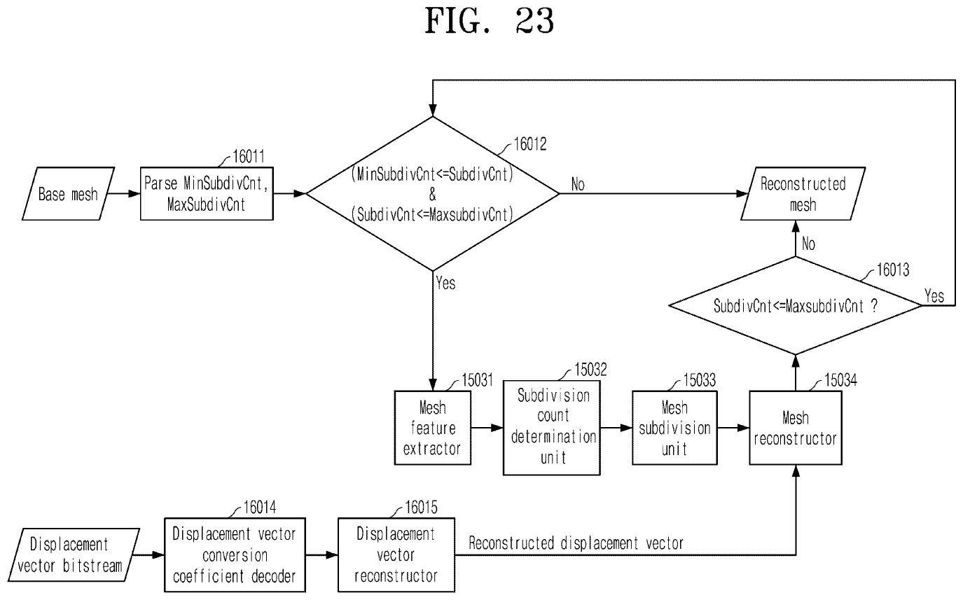

FIG. 23 is a diagram showing an example in which a dynamic mesh decoder performs a mesh subdivision process based on the mesh feature according to embodiments. That is, FIG. 23 shows an example of a process of performing mesh non-uniform subdivision based on the mesh feature in a dynamic mesh decoder according to embodiments. In adding reference numerals to components of FIG. 23, components that are the same or similar to those of FIG. 22 are given the same reference numbers, and repeated descriptions thereof may be omitted.

For convenience of explanation, in the present disclosure, reference numeral 16011 is referred to as a parsing unit, reference numeral 16012 is referred to as a first determination unit, and reference numeral 16013 is referred to as a second determination unit.

SubdivCnt may be defined as the current subdivision iteration count, MinSubdivCnt as the minimum subdivision iteration count, and MaxSubdivCnt as the maximum subdivision iteration count.

According to an embodiment of the present disclosure, MinSubdivCnt and MaxSubdivCnt are transmitted as signaling information from an encoder, and are parsed from the signaling information in the parsing unit 16011.

That is, according to the present disclosure, whether to perform a process of calculating the subdivision iteration count may be determined using the parsed MinSubdivCnt and MaxSubdivCnt.

In this case, MinSubdivCnt and MaxSubdivCnt may use the same value by agreement between the encoder of the transmitting apparatus and the decoder of the receiving apparatus, or may be obtained by parsing from signaling information transmitted from the encoder of the transmitting apparatus. In the latter case, MinSubdivCnt and MaxSubdivCnt may be transmitted on a patch basis, mesh sequence basis, or the like.

According to an embodiment of the present disclosure, a process of calculating the subdivision iteration count when SubdivCnt, which means the current subdivision iteration count, is greater than or equal to MinSubdivCnt and less than or equal to MaxSubdivCnt may be performed. In other words, according to an embodiment, the subdivision iteration count may be calculated based on the mesh feature and subdivision may be performed only when SubdivCnt is between MinSubdivCnt and MaxSubdivCnt. When the above condition is not satisfied, that is, when SubdivCnt is less than MinSubdivCnt or larger than MaxSubdivCnt, the process of calculating the mesh feature and performing subdivision may not be performed.

To this end, a first determination unit 16012 of FIG. 23 checks whether SubdivCnt is greater than or equal to MinSubdivCnt and less than or equal to MaxSubdivCnt. According to embodiments, the mesh feature extractor 15031 operates and extracts the mesh feature only when the first determination unit 16012 determines that SubdivCnt is greater than or equal to MinSubdivCnt and less than or equal to MaxSubdivCnt.

As such, the mesh feature extractor 15031 calculates the mesh feature when the conditions (SubdivCnt>=MinSubdivCnt) & (SubdivCnt<=MaxSubdivCnt) are satisfied, and the subdivision count determination unit 15032 determines the subdivision iteration count for each subdivision iteration unit based on the calculated mesh feature. The mesh subdivision unit 15033 may perform subdivision for each subdivision iteration unit based on the subdivision iteration count determined for each subdivision iteration unit.

According to the present disclosure, determination of the subdivision iteration count based on the mesh feature and subdivision may not be performed when the conditions (MinSubdivCnt<=SubdivCnt) & (SubdivCnt<=MaxSubdivCnt) are not satisfied. In this case, the displacement vector calculation and mesh reconstruction processes may be omitted.

Hereinafter, the mesh feature extractor 15031, the subdivision count determination unit 15032, the mesh subdivision unit 15033, the mesh reconstructor 15034, and a displacement vector reconstructor 16015 will be described in detail.

### Mesh Feature Extractor 15031

According to embodiments, the mesh feature extractor 15031 calculates the mesh feature.

In this case, a unit for calculating the mesh feature may be a vertex, a face, or a fan. That is, the mesh feature extractor 15031 may calculate the mesh feature in units of mesh vertices, in units of fans, or in units of faces.

According to embodiments, the types of mesh feature calculated by the mesh feature extractor 15031 may be curvature, convexity, concavity, planarity, dihedral angle, a degree of change in normal vector, motion vector feature, texture map feature, geodesic distances, or the like, and the mesh feature may be calculated based on one or more of these. An embodiment of the present disclosure is described in terms of curvature.

When the mesh feature is considered as curvature, the mesh feature extractor 15031 may calculate the mesh curvature through various algorithms. According to embodiments, the algorithm for calculating curvature may include Gaussian curvature, mean curvature, and principal curvature.

The same type of mesh feature may be calculated by an agreement between the encoder of the transmitting apparatus and the decoder of the receiving apparatus, or signaling information including information indicating the type of mesh feature used in the encoder (e.g., FeatureType) may be transmitted to the decoder of the receiving apparatus. In this case, the mesh feature is computed (or extracted) based on information parsed from signaling information (e.g., FeatureType).

### Subdivision Count Determination Unit 15032

According to embodiments, the subdivision count determination unit 15032 may determine the subdivision iteration count based on the mesh feature, which is calculated by the mesh feature extractor 15031.

In this case, a unit for determining the subdivision iteration count may be a face unit or a fan unit. That is, the subdivision count determination unit 15032 may determine the subdivision iteration count in units of faces based on the mesh feature extracted in units of vertices, faces, or fans, or may determine the subdivision iteration count in units of fans. In the present disclosure, a unit for determining the subdivision iteration count may be transmitted from the encoder of the transmitting apparatus, or may be determined as the same unit by agreement between the encoder of the transmitting apparatus and the decoder of the receiving apparatus. According to an embodiment of the present disclosure, determination of a subdivision iteration count in units of faces (e.g., triangle mesh unit) is described.

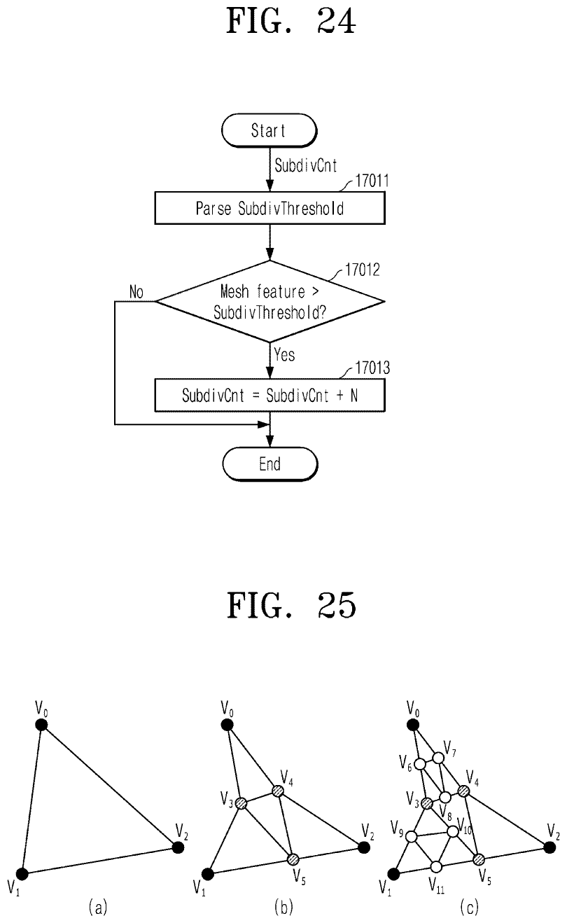

FIG. 24 is a diagram showing an example of a method of determining a subdivision iteration count according to embodiments. In FIG. 24, SubdivThreshold is a threshold used as a determination reference to determine the subdivision iteration count based on mesh feature (i.e., according to mesh feature).

In the present disclosure, SubdivThreshold may use the same value by agreement between the encoder of the transmitting apparatus and the decoder of the receiving apparatus, or may be obtained by parsing from signaling information transmitted from the encoder of the transmitting apparatus. When SubdivThreshold is included in signaling information and received by the decoder of the receiving apparatus, SubdivThreshold may be received on a patch basis, mesh sequence basis, or the like.

Referring to FIG. 24, a threshold (SubdivThreshold) is parsed from the signaling information (17011). Then, whether the mesh feature is larger than the parsed SubdivThreshold is checked (17012). When it is determined in operation 17012 that the mesh feature is greater than SubdivThreshold, the subdivision iteration count may be determined by adding N to SubdivCnt, which indicates the current subdivision iteration count (17013). Here, N may be a fixed value (e.g., 1). Alternatively, in operation 17013, an absolute value of a difference between the mesh feature and the threshold may be determined, and then the subdivision iteration count may also be determined in consideration of a ratio of the absolute value.

When the subdivision iteration count is determined in units of faces, the subdivision count determination unit 15032 may determine the subdivision iteration count for the corresponding face if feature values of some of the vertices constituting the face are greater than or equal to a threshold, or may determine the subdivision iteration count for the corresponding face if an average of the feature values of the vertices constituting the face is greater than or equal to the threshold.

### Mesh Subdivision Unit 15033

According to embodiments, the mesh subdivision unit 15033 may perform subdivision on the base mesh to generate additional vertices. That is, the mesh subdivision unit 15033 may generate a sub-mesh by performing a subdivision process that generates a new vertex in the middle of edges between vertices.

According to embodiments, the mesh subdivision unit 15033 may perform subdivision for each subdivision iteration unit according to the subdivision iteration count calculated (or determined) in the subdivision count determination unit 15032.

In this case, subdivision may be performed in the same subdivision iteration unit in the encoder of the transmitting apparatus and the decoder of the receiving apparatus depending on the subdivision iteration count. In this case, transmission of the subdivision iteration unit and the subdivision iteration count to the decoder may be omitted. That is, when calculating the subdivision iteration count according to the subdivision iteration unit based on the mesh feature by using the same manner in an encoder of a transmitting apparatus and a decoder of a receiving apparatus, transmission of the subdivision unit and subdivision iteration count to the decoder may be omitted. Here, the subdivision iteration count may be determined differently for each subdivision iteration unit.

According to embodiments, the subdivision iteration unit may be a face unit, a fan unit, or the like. The subdivision iteration unit may be a unit that uses a mesh subdivision algorithm to cluster faces having similar feature values by using feature values calculated in the mesh feature extractor 15031.

In the present disclosure, the subdivision iteration unit may be determined to be the same subdivision iteration unit by agreement between the encoder of the transmitting apparatus and the decoder of the receiving apparatus, or signaling information including information for identifying the subdivision iteration unit determined by the encoder may be received and parsed by the decoder.

According to embodiments, when the current mesh is a base mesh, the mesh subdivision unit 15033 may increase the subdivision iteration count calculated by the subdivision count determination unit 15032 by N, and then subdivide some areas of the base mesh N times. When the current mesh is a reconstructed mesh by applying a displacement vector after performing subdivision, the mesh subdivision unit 15033 may increase the subdivision iteration count by N and then subdivide some areas of the reconstructed mesh N times.

According to embodiments, the mesh subdivision method performed by the mesh subdivision unit 15033 may include Midpoint subdivision, Loop subdivision, Butterfly subdivision, and Catmull-Clark subdivision.

According to embodiments, the mesh subdivision method may perform subdivision by using the same mesh subdivision method by agreement between the encoder of the transmitting apparatus and the decoder of the receiving apparatus, or may receive and parse signaling information including information (e.g., SubdivMethod) for identifying the mesh subdivision method determined by the encoder by the decoder of the receiving apparatus.

FIG. 25(a) to 25(c) are diagrams showing an example of a mesh subdivision process according to embodiments. That is, FIG. 25(a) to 25(c) show examples of performing mesh non-uniform subdivision iterations in units of triangle meshes (or faces) based on mesh feature values.

In more detail, FIG. 25(a) to 25(c) show examples of repeatedly performing subdivision while increasing SubdivCnt, which is the subdivision iteration count, from 0 to 1 for an area (e.g., a triangle mesh or face) in which a mesh feature value is greater than a specific threshold until SubdivCnt is 2 assuming that MinSubdivCnt is 0 and MaxSubdivCnt is 2.

In this case, according to an embodiment, a unit for calculating the mesh feature value is a vertex unit, and a unit for performing subdivision is a face (i.e., a triangle mesh). For example, a feature value may be calculated for each vertex of the base mesh, and when an average feature value of the vertices within the face is greater than a threshold, subdivision of the corresponding face may be performed. As another example, the feature value may be calculated for each vertex of the base mesh, and subdivision may be performed on faces that have one or more vertices with feature values greater than a threshold among the vertices. This subdivision process is repeatedly performed as many times as the subdivision iteration count. This is merely one example, and a unit for calculating a mesh feature value may be any one of a vertex, a face, and a fan, and a unit for performing subdivision may be any one of a face and a fan.

According to the present disclosure, rather than performing subdivision on all faces that constitute the mesh, subdivision is performed only on faces that satisfy conditions based on the feature values of the mesh. Here, the mesh may be a base mesh, a mesh on which subdivision has been performed one or more times, or a mesh on which a displacement vector has been applied after subdivision.

According to an embodiment of the present disclosure, in FIG. 25(a) to 25(c), a unit for performing subdivision may be a face unit, and subdivision may be performed on a face that includes two or more vertices of which mesh feature values are greater than a threshold.

FIG. 25(a) shows a face of a portion of a base mesh according to embodiments. According to the present disclosure, it is assumed that feature values of vertices v₀ and v₁ in the base mesh of FIG. 25(a) are greater than a threshold. In this case, according to the present disclosure, subdivision is performed on Δv₀v₁v₂, which is a face to which the vertices v₀ and v₁ belong, i.e., a face that includes the vertices v₀ and v₁.

FIG. 25(b) shows an example of finding endpoints of edges that constitute a face and performing subdivision on the corresponding edges according to an embodiment. That is, FIG. 25(b) shows an example of finding the endpoints of the edges in Δv0v1v2 that constitute the corresponding face and performing subdivision on the corresponding edge under the above condition. For example, subdivision may be performed on edges v̅₀̅v̅₁̅v̅₀̅v̅₁̅ to generate a vertex v₃, subdivision may be performed on edges v̅₀̅v̅₂̅v̅₀̅v̅₂̅ to generate a vertex v₄, and subdivision may be performed on edges v̅₁̅v̅₂̅v̅₁̅v̅₂̅ to generate a vertex v₅.

According to the present disclosure, as shown in FIG. 25(b), a mesh feature value may be calculated again on a vertex basis for a mesh on which subdivision has been performed, and additional subdivision may be performed on a face that includes two or more vertices with mesh feature values greater than a threshold.

For example, when the feature value of the vertex v₃ generated through subdivision is greater than a threshold, subdivision may be performed on a face that includes an edge connected to a vertex having a feature value greater than the threshold by comparing the feature values of the vertices (e.g., v₀, v₁, v₄, and v₅) of the edges connected to vertex v₃ with the threshold.

In FIG. 25(b), it is assumed that the feature values of vertices v₀ and v₁ are greater than a threshold. That is, the feature value of the vertex v₀, the feature value of the vertex v₁, and the feature value of the vertex v₃ are greater than the threshold, and for example, feature values of endpoints of the edges v̅₀̅v̅₂̅v̅₀̅v̅₂̅ and v̅₁̅v̅₂̅v̅₁̅v̅₂̅ are greater than the threshold.

In this case, subdivision is performed on Δv₀v₃v₄ which is a face including an edge v̅₀̅v̅₂̅v̅₀̅v̅₂̅ and Δv₁v₃v₅ which is a face including an edge v̅₁̅v̅₂̅v̅₁̅v̅₂̅. For Δv₀v₃v₄ which is a face including an edge v̅₀̅v̅₂̅v̅₀̅v̅₂̅ as an example, subdivision may be performed on an edge v̅₀̅v̅₂̅v̅₀̅v̅₂̅ to generate a vertex v₆, subdivision may be performed on an edge v̅₀̅v̅₄̅v̅₀̅v̅₄̅ to generate a vertex v₇, and subdivision may be performed on an edge v̅₃̅v̅₄̅v̅₃̅v̅₄̅ to generate a vertex v₈. For Δv₁v₃v₅ which is a face including an edge v̅₁̅v̅₂̅v̅₁̅v̅₂̅ as an example, subdivision may be performed on an edge v̅₁̅v̅₂̅v̅₁̅v̅₂̅ to generate a vertex v₉, subdivision may be performed on an edge v̅₃̅v̅₅̅v̅₃̅v̅₅̅ to generate a vertex v₁₀, and subdivision may be performed on an edge v̅₁̅v̅₅̅v̅₁̅v̅₅̅ to generate a vertex v₁₁.

That is, FIG. 25(c) shows the result of calculating a feature value for each vertex of a mesh to which a displacement vector has been applied after performing non-uniform subdivision once, and then re-subdividing the corresponding face(s) that include one or more vertices of which calculated feature value is greater than a specific threshold.

### Displacement Vector Conversion Coefficient Decoder 16014

According to embodiments, the displacement vector conversion coefficient decoder 16014 may be referred to as a displacement vector decoder, and decodes a displacement vector in a reverse process of the displacement vector encoding method of the transmitting side. That is, the displacement vector conversion coefficient decoder 16014 receives a displacement vector bitstream and decodes the displacement vector conversion coefficient. According to embodiments, a method of decoding a displacement vector conversion coefficient may include a video-based decoding method, a zero run length decoding method, and an arithmetic decoding method. When the encoding method in the transmitting apparatus is based on video encoding, the displacement vector conversion coefficient decoder 16014 may decode the displacement vector bitstream based on a video decoder and then perform a process of depacking a displacement vector conversion coefficient frame. When the displacement vector encoding process in the transmitting apparatus is lossless compression, the displacement vector conversion coefficient decoder 16014 may be omitted.

### Displacement Vector Reconstructor 16015

According to embodiments of the present disclosure, a vector inverse converter 15018, the displacement vector inverse quantizer 15019, and the displacement vector coordinate system inverse converter 15020 of FIG. 22 may be collectively referred to as the displacement vector reconstructor 16015.

That is, the displacement vector reconstructor 16015 may generate a final reconstructed displacement vector by performing a reverse process of the method of encoding the displacement vector in the transmitting apparatus. For example, when the displacement vector is encoded based on a video codec in the transmitting apparatus, displacement vector depacking may be performed, and then dequantization, inverse transformation, or the like may be performed. As another example, when the displacement vector is encoded based on entropy coding in the transmitting apparatus, the displacement vector may be dequantized, inversely transformed, or the like.

### Mesh Reconstructor 15034

According to embodiments, the mesh reconstructor 15034 reconstructs the mesh by applying the displacement vector reconstructed by the displacement vector reconstructor 16015 to the mesh on which non-uniform subdivision has been performed according to the subdivision iteration count determined through a subdivision count determination unit 15033.

According to embodiments, the mesh reconstructor 15034 may repeatedly perform a process of increasing the subdivision iteration count by an arbitrary value, calculating a displacement vector of the generated vertex, and applying the displacement vector to the subdivided mesh.

According to embodiments, the mesh reconstructor 15034 may determine the mesh reconstruction process by using the displacement vector calculation process performed in the displacement vector calculator of the encoder of the transmitting apparatus.

For example, when the displacement vector calculator of the encoder of the transmitting apparatus calculates the displacement vector by using the subdivided mesh each time the subdivision iteration count is increased by N, the mesh reconstructor 15034 of the receiving apparatus may also repeatedly perform the process of reconstructing the subdivided mesh and applying the displacement vector to reconstruct the mesh each time the subdivisions are performed N times in the same manner.

As another example, when calculating a displacement vector for a subdivided mesh that has completed a subdivision process in the displacement vector calculator of the encoder of the transmitting apparatus, the mesh reconstructor 15034 of the receiving apparatus may also apply the reconstructed displacement vector to the mesh that has completed the subdivision process in the same manner.

In the present disclosure, the reconstructed displacement vectors may be sorted and stored in the order in which vertices are generated from the base mesh.

When the order of the vertices generated by performing subdivision is as shown in FIG. 25(c), that is, when the vertices are generated in the order of {v₀, v₁, v₂, v₃, v₄, v₅, v₆, v₇, v₈, v₉, v₁₀, v₁₁}, the displacement vector may also be mapped in the order of vertex indexes and sorted and stored in the form {d₀, d₁, d₂, d₃, d₄, d₅, d₆, d₇, d₈, d₉, d₁₀, d₁₁}, and thus the displacement vector may be applied to vertices having the same index. Here, vᵢ means the vertex coordinates of an i-th index, and dᵢ means a displacement vector of the i-th index.

To perform non-uniform subdivision on a mesh in the encoder of the transmitting apparatus and/or the decoder of the receiving apparatus as described above, the encoder of the transmitting apparatus may transmit signaling information including subdivision-related information to the decoder of the receiving apparatus. In this case, the decoder of the receiving apparatus may parse signaling information to parse information related to subdivision and perform non-uniform subdivision on the mesh based on the parsed information related to subdivision.

According to embodiments, signaling information in the transmitting apparatus may be generated in a metadata processor (not shown, may be referred to as a metadata generator, or the like) and provided to corresponding blocks in the transmitting apparatus and/or the receiving apparatus (or a decoder of the receiving apparatus), and a metadata parser (not shown) of the receiving apparatus may parse the received signaling information and provide it to the corresponding blocks. According to embodiments, each block of the receiving apparatus may perform each operation based on the signaling information.

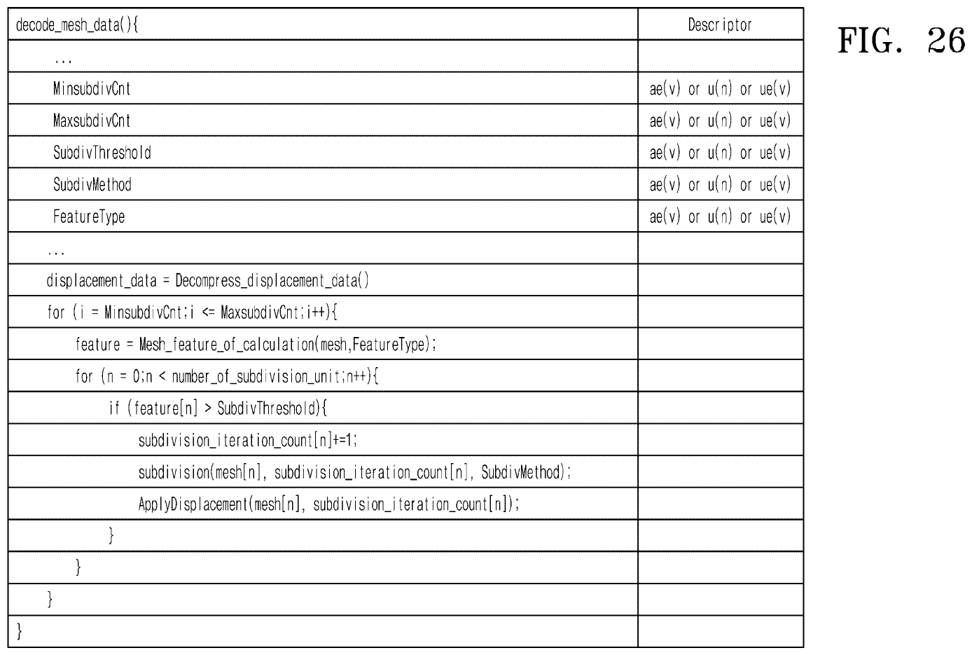

FIG. 26 is a diagram showing an example of a syntax structure of information (decode_mesh_data( )) related to subdivision among signaling information according to embodiments.

According to embodiments, information related to subdivision may include a MinSubdivCnt field, a MaxSubdivCnt field, a SubdivMethod field, a SubdivThreshold field, and a FeatureType field.

The MinSubdivCnt field may indicate the minimum number of mesh subdivisions performed (i.e., the minimum number of subdivisions performed), and the MaxSubdivCnt field may indicate the maximum number of mesh subdivisions performed (i.e., the maximum number of subdivisions performed).

The SubdivThreshold field indicates a threshold used as a determination reference for determining the subdivision iteration count based on a mesh feature value. According to an embodiment of the present disclosure, a face for subdivision may be determined based on a vertex of which mesh feature value is greater than a value of the SubdivThreshold field.

The SubdivMethod field may indicate a mesh subdivision method. For example, the SubdivMethod field may indicate at least one of Midpoint subdivision, Loop subdivision, Butterfly subdivision, or Catmull-Clark subdivision.

The FeatureType field may indicate a type of mesh feature used for calculation in the mesh feature extractor. For example, the FeatureType field may indicate at least one of curvature, convexity, concavity, planarity, dihedral angle, degree of change in normal vector, motion vector feature, texture map feature, or geodesic distances.

According to embodiments, the subdivision-related information may include a first iteration that is repeated as many times as the SubdivCnt value. That is, SubdivCnt represents the current subdivision iteration count and may increase from the MinSubdivCnt field value to the MaxSubdivCnt field value. That is, i corresponds to SubdivCnt, is initialized to a value of the MinSubdivCnt field, increases by 1 each time the first iteration is performed, and the first iteration is repeated until the value of i is the value of the MaxSubdivCnt field.

According to the embodiments, the first iteration calculates the feature value of the mesh by calling a function ‘Mesh_feature_calculation (mesh, FeatureType)’ based on the mesh feature method corresponding to the values of the mesh and FeatureType fields, and assigns (or returns) the calculated mesh feature value to a variable ‘feature’. That is, the variable ‘feature’ represents a feature value of the mesh calculated by the function Mesh_feature_calculation.

According to embodiments, the first iteration may include a second iteration that is repeated a number of times (number_of_subdivision_unit). In this case, n is initialized to 0 and increases by 1 each time the second iteration is executed, and the second iteration is repeated until a value of n becomes a value of number_of_subdivision_unit. Here, a subdivision unit (or subdivision iteration unit) may be a face, a fan, or a smaller unit.

In this case, when a feature value of an n-th subdivision unit is greater than a threshold (SuddivThreshold), the subdivision iteration count for the n-th subdivision unit is increased by 1, and subdivision is performed on a mesh of the n-th subdivision unit based on the subdivision method (SubdivMethod). The mesh is reconstructed by applying the displacement vector to the mesh of the n-th subdivision unit in which subdivision is performed.

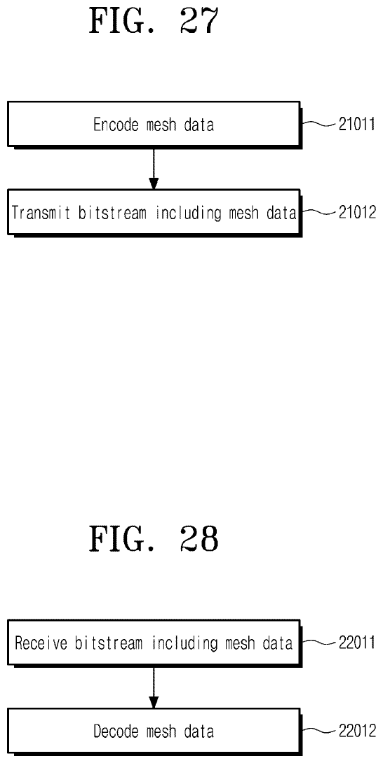

FIG. 27 is a flowchart showing an example of a transmission method according to embodiments. The transmission method according to embodiments may include operation 21011 of encoding mesh data and operation 21012 of transmitting a bitstream including the encoded mesh data.

According to embodiments, in operation 21011 of encoding mesh data, a mesh feature value is calculated (or extracted) in at least one unit of a vertex unit, a face unit, or a fan unit, and whether to perform subdivision and the subdivision iteration count in a corresponding subdivision iteration unit (e.g., face) is determined based on the calculated mesh feature value. For example, when the subdivision iteration count is determined in units of faces, the subdivision iteration count for subdivision of the corresponding face may be determined if feature values of some of the vertices constituting the face are greater than or equal to a threshold, or the subdivision iteration count for subdivision of the corresponding face may be determined if an average of the feature values of the vertices constituting the face is greater than or equal to the threshold. That is, whether to perform subdivision and the subdivision iteration count are determined for each face unit based on the mesh feature value. For detailed descriptions on calculation of a mesh feature value, determination of whether to perform subdivision in the subdivision iteration unit based on a mesh feature value, and determination of the subdivision iteration count, the descriptions in FIGS. 15 to 21 are referenced, and the detailed descriptions are omitted here to avoid redundant description. For detailed descriptions of signaling information including information related to segmentation, FIG. 26 is referenced.

FIG. 28 is a flowchart showing an example of a receiving method according to embodiments. The receiving method according to embodiments may include operation 22011 of receiving a bitstream including mesh data and operation 22012 of decoding the mesh data included in the bitstream.

In the present disclosure, in operation 22012 of decoding mesh data included in the bitstream, calculation of a mesh feature value, and determination of whether to perform subdivision for each subdivision iteration unit according to the calculated mesh feature value and the subdivision iteration count may be performed in the same method as the method performed in the encoder of the transmitting apparatus by agreement between the encoder of the transmitting apparatus and the decoder of the receiving apparatus. Alternatively, based on subdivision-related information included in signaling information, calculation of a mesh feature value, and determination of whether to perform subdivision and the subdivision iteration count for each subdivision iteration unit based on the calculated mesh feature value may be performed.

That is, in operation 22012 of decoding mesh data included in the bitstream, the mesh feature value is also calculated (or extracted) in at least one unit of a vertex unit, a face unit, or a fan unit, and whether to perform subdivision and the subdivision iteration count in a corresponding subdivision iteration unit (e.g., face) is determined based on the calculated mesh feature value. For example, when the subdivision iteration count is determined in units of faces, the subdivision iteration count for subdivision of the corresponding face may be determined if feature values of some of the vertices constituting the face are greater than or equal to a threshold, or the subdivision iteration count for subdivision of the corresponding face may be determined if an average of the feature values of the vertices constituting the face is greater than or equal to the threshold. That is, whether to perform subdivision and the subdivision iteration count are determined for each face unit based on the mesh feature value. In this case, for detailed descriptions on calculation of a mesh feature value, determination of whether to perform subdivision in the subdivision iteration unit based on a mesh feature value, and determination of the subdivision iteration count, the descriptions in FIGS. 22 to 25 are referenced, and the detailed descriptions are omitted here to avoid redundant description. For detailed descriptions of signaling information including information related to segmentation, FIG. 26 is referenced.

As such, the existing V-Mesh compression method adaptively derives the subdivision iteration count of the dynamic mesh for each subdivision iteration unit based on the mesh feature and performs subdivision. That is, in the present disclosure, by adaptively applying the subdivision iteration count of the dynamic mesh according to the feature of a mesh surface, or the like, transmission of information about whether to perform subdivision and subdivision iteration count may be omitted. By adaptively setting a subdivision level, there is an advantage in that the amount of displacement vector bits may be reduced as the number of vertices to be reconstructed is reduced when subdivision is not performed for a specific subdivision unit.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

In the specification, when a part “comprises” or “includes” an element, it means that the part further comprises or includes another element unless otherwise mentioned. Also, the term “... module(or unit)” disclosed in the specification means a unit for processing at least one function or operation, and may be implemented by hardware, software or combination of hardware and software.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods may not be limited by the configurations and methods of the embodiments described above. The embodiments described above may be configured by being selectively combined with one another entirely or in part to enable various modifications.

Although preferred embodiments of the embodiments have been shown and described, the embodiments are not limited to the specific embodiments described above, and various modifications may be made by one of ordinary skill in the art without departing from the spirit of the embodiments claimed in the claims, and such modifications should not be understood in isolation from the technical ideas or views of the embodiments.

Various elements of the apparatuses of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the apparatus according to the embodiments may include one or more processors capable of executing one or more programs. The one or more programs may perform any one or more of the operations/methods according to the embodiments or include instructions for performing the same. Executable instructions for performing the method/operations of the apparatus according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

Various elements of the embodiments may be implemented by hardware, software, firmware, or a combination thereof. Various elements in the embodiments may be executed by a single chip such as a single hardware circuit. According to embodiments, the element may be selectively executed by separate chips, respectively. According to embodiments, at least one of the elements of the embodiments may be executed in one or more processors including instructions for performing operations according to the embodiments.

Operations according to the embodiments described in this specification may be performed by a transmission/reception apparatus including one or more memories and/or one or more processors according to embodiments. The one or more memories may store programs for processing/controlling the operations according to the embodiments, and the one or more processors may control various operations described in this specification. The one or more processors may be referred to as a controller or the like. In embodiments, operations may be performed by firmware, software, and/or combinations thereof. The firmware, software, and/or combinations thereof may be stored in the processor or the memory.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise. The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components.

As used herein, conditional expressions such as “if” and “when” are not limited to an optional case and are intended to be interpreted, when a specific condition is satisfied, to perform the related operation or interpret the related definition according to the specific condition. Embodiments may include variations/modifications within the scope of the claims and their equivalents. It will be apparent to those skilled in the art that various modifications and variations may be made in the present disclosure without departing from the spirit and scope of the disclosure. Thus, it is intended that the present disclosure cover the modifications and variations of the present disclosure provided they come within the scope of the appended claims and their equivalents.

### MODE FOR DISCLOSURE

As described above, related contents have been described in the best mode for carrying out the embodiments.

### INDUSTRIAL APPLICABILITY

As described above, the embodiments may be fully or partially applied to the 3D data transmission/reception apparatus and system. It will be apparent to those skilled in the art that various changes or modifications may be made to the embodiments within the scope of the embodiments. Thus, it is intended that the embodiments cover modifications and variations provided they come within the scope of the appended claims and their equivalents.

1. A three-dimensional (3D) data decoding apparatus comprising:
a base mesh reconstructor configured to reconstruct a base mesh from a base mesh bitstream;
a displacement vector reconstructor configured to reconstruct a displacement vector from a displacement vector bitstream;
a reconstructor configured to reconstruct a mesh based on the reconstructed base mesh and the reconstructed displacement vector; and
a texture map reconstructor configured to reconstruct a texture map from a texture map bitstream.

2. The 3D data decoding apparatus of claim 1, further comprising:
a mesh feature extractor configured to extract a feature value of the base mesh or subdivided mesh for each preset unit;
an iteration count determination unit configured to determine whether to perform subdivision and a subdivision iteration count for each subdivision unit based on the extracted feature value; and
a mesh subdivision unit configured to subdivide a mesh of a corresponding subdivision unit based on the determined subdivision iteration count.

3. The 3D data decoding apparatus of claim 2, wherein the preset unit is at least one of a vertex unit, a face unit, or a fan unit.

4. The 3D data decoding apparatus of claim 2, wherein the subdivision unit is a base mesh of a face unit or a reconstructed mesh of a face unit.

5. The 3D data decoding apparatus of claim 4, wherein the reconstructed mesh of the face unit is a mesh reconstructed by applying a reconstructed displacement vector to a mesh of a subdivided face.

6. A three-dimensional (3D) data encoding apparatus comprising:
a base mesh processor configured to generate a base mesh bitstream by encoding a base mesh generated by decimating an original mesh;
a displacement vector processor configured to generate a displacement vector bitstream by encoding a displacement vector generated based on the base mesh;
a mesh reconstructor configured to reconstruct a mesh based on the encoded base mesh and the encoded displacement vector; and
a texture map processor configured to generate a texture map bitstream by encoding a texture map generated based on the original mesh and the reconstructed mesh.

7. The 3D data encoding apparatus of claim 6, further comprising:
a mesh feature extractor configured to extract a feature value of the base mesh or subdivided mesh for each preset unit;
an iteration count determination unit configured to determine whether to perform subdivision and a subdivision iteration count for each subdivision unit based on the extracted feature value; and
a mesh subdivision unit configured to subdivide a mesh of a corresponding subdivision unit based on the determined subdivision iteration count.

8. The 3D data encoding apparatus of claim 7, wherein the preset unit is at least one of a vertex unit, a face unit, or a fan unit.

9. The 3D data encoding apparatus of claim 7, wherein the subdivision unit is a base mesh of a face unit or a reconstructed mesh of a face unit.

10. The 3D data encoding apparatus of claim 9, wherein the reconstructed mesh of the face unit is a mesh reconstructed by applying a reconstructed displacement vector to a mesh of a subdivided face.

11. A three-dimensional (3D) data transmission method comprising:
encoding an original mesh; and
transmitting a bitstream including the encoded mesh and signaling information.

12. The 3D data transmission method of claim 11, wherein the encoding includes:
generating a base mesh bitstream by encoding a base mesh generated by decimating the original mesh;
generating a displacement vector bitstream by encoding a displacement vector generated based on the base mesh;
reconstructing a mesh based on the encoded base mesh and the encoded displacement vector; and
generating a texture map bitstream by encoding a texture map generated based on the original mesh and the reconstructed mesh.

13. The 3D data transmission method of claim 12, wherein the encoding includes:
extracting a feature value of the base mesh or subdivided mesh for each preset unit;
determining whether to perform subdivision and a subdivision iteration count for each subdivision unit based on the extracted feature value; and
subdividing a mesh of a corresponding subdivision unit based on the determined subdivision iteration count.

14. The 3D data transmission method of claim 13, wherein the preset unit is at least one of a vertex unit, a face unit, or a fan unit.

15. The 3D data transmission method of claim 13, wherein the subdivision unit is a base mesh of a face unit or a reconstructed mesh of a face unit.

16. The 3D data transmission method of claim 15, wherein the reconstructed mesh of the face unit is a mesh reconstructed by applying a reconstructed displacement vector to a mesh of a subdivided face.

17. A computer-readable recording medium combined with a computer as hardware and recording a computer program for executing the method of claim 11.
